(19) United States
(12) Patent Application Publication
(10) Pub. No.: US 2003/0167454 A1
(43) Pub. Date: Sep. 4, 2003

(54) Method of and system for providing metacognitive processing for simulating cognitive tasks

(76) Inventors: Vassil Iordanov, Horsham, PA (US); JC LeMentec, Champain, IL (US); Wayne Zachary, Fort Washington, PA (US)

Correspondence Address: KNOBLE & YOSHIDA, LLC, Suite 1350, Eight Penn Center, 1628 John F. Kennedy Blvd., Philadelphia, PA, 19103, US

(21) Appl. No.: 09/823,103

(22) Filed: Mar. 30, 2001

(51) Int. Cl. G06F 9/44

(52) U.S. Cl. 717/104

(57) ABSTRACT

The human behavior simulator and method with metacognitive capability enhances the quality of simulation for behavioral simulation and decision making processes by generating, storing and updating information on internal aspects of the resources that are involved in processing cognitive tasks. A cognitive proprioception unit detects any internal change among the resources and updates symbolic knowledge that represent the internal aspects of the resources.

### FIELD OF THE INVENTION

The current invention is generally related to human performance modeling and computer generated human behavioral representation, and more particularly related to metacognition processes for simulating cognitive tasks.

### BACKGROUND OF THE INVENTION

### INTRODUCTION

The research for human performance models has been motivated by the great advances in simulation technology in the past decade, and the need for more realistic representation of human (cognition and) behavior in the current and next generations of simulations. Of particular relevance has been the development of distributed constructive simulations, in which real humans and synthetic forces have been able to interact and conduct large scale exercises for training, mission rehearsal, and system/tactics evaluation purposes. While the human players and the system/environmental/platform simulations have typically performed well, the behavior of automated and semi-automated forces have often been suspect in these simulations. This has created a strong interest in the possibility of developing specialized simulation technologies to generate realistic human behavior.

### ISSUES IN COMPUTER-GENERATED FORCE MODELING

The use of interactive and constructive simulation in military training has become increasingly widespread in recent years. While computer simulation of physical and mechanical systems has a long history, the current generation of applications has added a major focus on representing and simulating human behavior as well. Such human behavioral representation (HBR) is seen as having the potential to greatly reduce the costs of conducting simulation-based training, by allowing simulation of large-scale operations in which many, or even most, of the friendly and/or adversary forces could be synthetic.

The technology for creating HBR in such computer-generated forces (CGFs), however, is still in an early stage (see Pew and Mavor, 1998, for a comprehensive review). The current HBR technology has roots in several different areas. One, and probably the most widely used, technology source for representing human behavior in CGFs is a behavioral extension of the standard computer-science approach of discrete event simulation. Discrete event simulation HBR engines have been created based on event classes oriented toward human behavior, e.g., MicroSaint (Laughery and Corker, 1997), IPME, and ModSaf (Ceranowitz, 1994). These tools, particularly ModSAF, have been used to create large and complex CGF models with extensive HBR. However, the human behavior generated in these models is criticized as being brittle, rote, and/or frequently unrealistic. Another source of human behavioral representations in CGFs lies in the psychology and cognitive science research in cognitive modeling. This body of work has created very sophisticated models of human cognition based on theories of underlying cognitive architecture and information processing; e.g., SOAR (Newell, 1990), ACT-R (Byrne and Anderson, 1998), or EPIC, (Kieras & Meyer, 1995). These models when supplied with appropriate domain knowledge, can be used to create intelligent behavior representations in specific domains. However, to date, they have generally not been used to generate large-scale CGF applications, and are constrained by the complexity of their representational systems and the high degree of expertise needed to create working models with them. The major exception to this has been the TACAIR SOAR model (see Jones et al., 1999) which represents both friendly and adversary air elements in a large-scale simulation called JOINT-SAF (see Ceranowitz, 2000).

Other approaches that have been successfully used to generate human-behavioral representations in simulations include optimal control models; e.g., PROCRU, (Baron, Zacharias, Muralidharan & Lancraft, 1980) and SAMPLE (Mulgrund, Harper, & Zacharias, 2000), and neural network models (see Pew and Mavor, 1998: 79-84 for a review in the HBR context). However, neither of these approaches has been used widely or employed to create any large-scale CGF models.

Neither of the discrete event approaches, with their engineering orientation nor the pure cognitive modeling approaches, with their psychological-theory orientation, was created directly to address the needs and problems of HBR in CGFs. Rather, they represent attempts to borrow or apply technology developed for other purposes to the problem. Of course, it should be noted that the behavioral representation problem in CGF actually post-dates both discrete event simulation and cognitive modeling. Still, at this point in time, it is worthwhile to reconsider the problem on its own terms and speculate on what characteristics might be most important in a technology specifically created to represent human behavior in CGFs.

Largely as a result of this interest, the National Research Council (NRC) undertook, in the latter 1990s, a detailed analysis of existing technology for simulating individual and team behavior. In the results of that study (Pew and Mavor, Eds., 1998), the NRC panel pointed out the great difficulty of achieving the goal of highly realistic, fully automated, computer-generated forces. At the same time, the panel identified the value of and need for integrative approaches that captured several different aspects of human behavior in a single simulation model/framework. The panel furthermore identified a set of existing integrative architectures that exemplified that approach, and recommended long-term efforts to further extend and build upon such architectures. The main motivation for research reported here was derived from the NRC recommendations. The general goal of combining two of the reviewed architectures, COGNET and Human Operation Simulator (HOS), will be described below. COGNET historically stands for “COGnition as a NEtwork of Tasks' but the original naming description is no longer accurate and COGNET is not limited by the above original description”. It is desired that the two of architectures integrate additional component technology (such as separate research into metacognition) into a more powerful and capable framework for generating human behavioral representations for computer-generated forces simulations.

HOS Development History

Wherry (1969) originally proposed the concept of a HOS as an alternative to the highly subjective estimating process required by other approaches. Instead, HOS would generate predictions of task performance time and accuracy based on objective, model-based estimates for task-element performance parameters such as hand movement distances, display element sizes, etc.. This would be accomplished by using general-purpose ‘micro-models’ for human performance to generate the times and accuracies needed for predicting performance at the task element level. The HOS user would construct a hierarchical task analysis using an English-like control language. The task hierarchy would start at the mission level, which the user would decompose iteratively into subordinate procedures until a bottom level of procedure specification was reached (i.e., the task element level) at which all actions could be specified in terms of a few action verbs which had predefined connections to a set of general human performance micro-models. Thus, the promise of HOS was that it would permit the user to transform a task analysis into a timeline without the requirement for the user to generate subjective estimates for the task element times. The HOS action verbs did not, however, correspond one-to-one with the micro-models, rather, general procedures called selection models were incorporated in HOS to define how the verb actions were accomplished with the different classes of objects represented in HOS. Yet another special feature of HOS was the assumption that the simulated operator has just a single channel of attention which could be switched rapidly between procedures to simulate parallel, multi-tasking performance.

Unlike other task network models, the user of HOS was required to model the behavior of the system and the environment as they interacted with the tasks performed by the operator because many aspects of performance were recognized to depend significantly on system and interface characteristics. Although the construction of such system and environment models was often difficult and time consuming, their incorporation in HOS was necessary to provide an explicit, traceable dependence of performance on features of interface and system design.

Following its conception in the late 1960s, HOS was developed through several stages by the US Navy, culminating in a complete, mainframe-based version designated as HOS-III which was applied to the simulation of several major Navy systems in the mid 1970s. The US Army subsequently sponsored the development of a version of HOS, known as HOS-IV, to operate in a PC environment, and a final version (HOS-V) which was compatible with the HARDMAN-III MANPRINT tools. In order to make the HOS capabilities accessible to HARDMAN III, HOS-V required a user interface which followed the same highly structured interface guidelines as the other HARDMAN III tools. HOS-V also allows the user to modify the human performance micro-models and the selection models which define when and how the micro-models are applied.

HOS-V Organization and Functionality

The HOS approach assumes that the human is primarily a single channel processor and that parallel performance of tasks is accomplished by rapidly switching attention back and forth between the tasks being performed at the same time. HOS assumes that some ballistic or automatic activities can occur in parallel with other activities, but most perceptual and cognitive activities are assumed to require a common attentional resource. Thus, HOS attempts to avoid subjective judgments about resource loads and thresholds by modeling the fine-grained resource activities. Other workload modeling approaches tend to use a much more molar approach than HOS, forcing the assumption of parallel processing and thereby permitting a much smaller quantity of user input specifications than required by HOS for a similar application.

The HOS-V architecture was designed to support two primary functions: (1) the creation and editing of task simulations and (2) the execution of task simulations to produce simulation output. FIG. 1 provides an overview of the organization and high level components developed within the HOS-V architecture, using Data Flow Diagram notation.

The process (bubbles) in FIG. 1 correspond to the major HOS-V software modules supporting simulation creation/editing (Simulation Editors, Customization Editors, and Object Editors), simulation execution (Simulation Consistency Checker, Task Manager, Attention Manager, Task Execution Manager, Resource Manager, and Data Analyzer) or both (Simulation Library Manger, Customization Library Manager, and Object Manger). The major data stores in HOS-V are the Simulation Library 19, Customization Library 20, and Object Library 22, which contain the data used to specify each simulation and control its execution. The major end-point of information in the HOS-V system is the user who interacts with HOS-V to create a simulation and interpret its output. The roles of the component HOS-V modules are as follows:

HOS-V Simulation Editors 4 allow the user to enter and modify the various aspects of task, subtask, and global variable data required for the specification of a HOS-V simulation.

Customization Editors 6 allow HOS-V users to customize selection models and micro-models, which describe a simulated operator's behavior on a low-level second-by-second basis. These models are intended to be used in a modular fashion within higher-level descriptions of operator behavior at the task and subtask level, so that once created, they will need to be altered only occasionally.

Object Editors 8 allow HOS-V users to create and tailor the definition of the object classes and characteristics of the object instances that the simulated operator will perceive and manipulate in his simulated environment during the simulation.

The Simulation Consistency Checker 10 examines the syntactic correctness of simulation control instructions and checks variable, object, and subtask references for completeness and consistency prior to simulation execution. The operation of the Simulation Consistency Checker is covered in a subsection on Execution Control.

The HOS-Y Attention Manager 12 allocates the flow of attention (i.e., determines what should be done next) among the various competing actions that a simulated operator could perform at a given time, based on the various subtasks of differing priority that are under active consideration.

The HOS-V Task Manager 14 parses and maintains position within task and subtask simulation control instructions as they are interpreted one line at a time and passed to the Task Execution Manager 28 for execution.

The Resource Manager 16 tracks the cognitive resource requirements and physical objects involved in operator actions to support limited parallelism in simulated action performance while avoiding resource conflicts.

The Data Analyzer 18 reads in the Simulation Output Data Store and assists the user in generating various descriptive statistics on the simulation run.

The Simulation Library Manager 20, Customization Library Manager 24, and Object Manager 26 each have an associated editor and data store.

FIG. 2 shows the organization of the various types of data required to specify a complete HOS-V simulation. HOS-V Data 30 may be roughly sorted into three groupings: Object Descriptions 31, Low-level Operator Models 32, and Task Analysis 34 for high level simulation control. A more detailed breakdown to the level of individual control statements and data elements is as follows:

Object Classes 36—includes specification of Class Name, Superclass Name, Attribute Names, and Attribute Types

Object Instances 38—includes specification of Instance Name, Instance Class, and Attribute Values

Selection Models 40—includes specification of Selection Model Name, Selection Model Description, Input Parameters, Local Variables, Utility Statements, Sequencing Statements, and Cognitive Resource Requirements

Micro-models 42—includes specification of Micro-model Name, Micro-model Description, Input Parameters, Local Variables, Utility Statements, and Sequencing Statements

Global Variables 44—includes specification of Variable Names and Variable Types

Simulation Task 46—includes specification of Simulation Name, Task Priority, Local Variables, Subtask Calls, Action Calls, Utility Statements, and Sequencing Statements

Subtask 48—includes specification of Subtask Name, Local Variables, Subtask Calls, Action Calls, Utility Statements, and Sequencing Statements

COGNET Overview

COGNET was based on an explicit decomposition, as reflected in the metaphorical ‘equation’ shown in Equation [1], which is analogous to the equation used by Card, Moran, and Newell to decompose human-computer interaction (1983: p.27). The focus of this equation is competence (in the sense used by linguists)—the ability of a person to construct appropriate behaviors in a specific context, unburdened by various constraining factors of performance or pragmatics.

$$Individual Competence = processing mechanisms + internal expertise + context \qquad Equation [ 1 ]$$

Through Equation [1], COGNET views competent problem-solving emerging from the manipulation of a body of internal expertise by a set of (presumably biological) internal information processing mechanisms, as required by the features of and interactions with the external context of the behavior. The ability to interact with this external context gave COGNET a minimal embodiment in the form of a perceptual process and an action process. However, these processes were in no way constrained to behave like human perceptual/motor processes.

COGNET Information Processing Mechanisms

The COGNET information processing mechanisms are defined in terms of their structure, (i.e., what the mechanisms are and how they are interconnected), and their function (i.e., what they do and the principles by which they operate). The overall architecture of COGNET processing mechanisms follows a well-established breakdown along the lines established by Broadbent (1958), Card, Moran and Newell (1983), and Newell (1990), among others. It postulates fully parallel perceptual, motor and cognitive sub-systems, with the cognitive and perceptual sub-systems sharing independent access to a memory structure. This is a theory-neutral position, given that it is consistent with all the symbolically-oriented architectures reviewed in Pew and Mavor (1998), plus several other discussed in a related report from the UK perspective (Ritter, Shadbolt, Elliman, Young, Gobet & Baxter, 1999). The memory construct in the underlying COGNET framework is a long-term working memory structure, that subsumes operations that have been ascribed in the literature to short term, long term and working memory. Ericcson and Kintsch (1995) argue for this type of organization from empirical data, while McGaugh (2000) supports similar arguments from an essentially neurophysiological perspective. Here again, the as-if nature of the COGNET model needs to be noted. COGNET does not presume that short-term and long-term memory differences do not exist, but merely that cognitive processes can be modeled without these distinctions. Ideally, analysis of applications of the resulting models can shed light on when and where such constructs are needed to achieve specific modeling goals.

The information processing mechanisms within the pre-existing COGNET framework are shown in FIG. 3. The high level components include a motor action module 120, a sensation and perception module 130, an extended working memory module 140 and a cognition module 150. The motor action module 120 and the sensation and perception module 130 directly interact with the outside world (external context), or simulation of it, 110. The motor action module 20 outputs signals indicative physical and/or verbal actions in response to the cognition module 150 which processes a cognitive task. The sensation and perception modules receives signals generating a signal indicative of the inputted cues, and the extended working memory module 140 stores the generated signal for the cognition module 150 to share.

The principles of operation of the architectural components in FIG. 3 have been derived from a number of more detailed theories and models, largely based on the purposes for which the framework was designed. The COGNET principles of operation are summarized in Table 1. These principles are examined in greater detail later, as a way of explaining the differences between COGNET and the CGF-COGNET architecture, which represent a preferred embodiment of the invention.

COGNET Internal Expertise Framework

The second major component of the COGNET framework suggested by Equation [1] is the representation of internal expertise—the internal information that is processed and manipulated by the information processing mechanisms. The types and overall structure of expertise in COGNET are largely defined by the principles of operation and information processing mechanisms. COGNET decomposes internal information into four basic types of expertise:

declarative expertise—units of knowledge which contain state/attribute information about (i.e., describe) the external environment, the problem/situation being addressed by the system, and the problem-solving process itself.

procedural expertise—units of knowledge that define goal states and information manipulations (e.g., inferences, physical actions) that can achieve those states.

action expertise—the units of knowledge that define transactions of the motor system that can be used to implement intended effects/actions in the external environment.

perceptual expertise—the units of knowledge that define processing operations to generate/transform internal information in response to information that is sensed from the external environment.

In terms of the COGNET architecture:

declarative knowledge is maintained in memory, and modified by both perceptual and cognitive processes.

procedural knowledge is executed by the cognitive process, and both manipulates information in (declarative) memory, and activates action knowledge for execution by the motor system.

action knowledge is processed by the action/motor system, and manipulates the external environment.

perceptual knowledge is executed by the perceptual process as information is sensed in the external environment. As the perceptual knowledge is executed, it manipulates information in the (declarative) memory.

The overall strategy for representation of each of these types of expertise is driven by the focus of the overall COGNET system as discussed earlier—on expert-level competence in complex real-time environments. Theories of expertise and skill acquisition clearly point to the fact that experts rely, within their domain of expertise, on rich and highly compiled knowledge structures which have chunked many lower level productions into contingent structures that minimize the search of the knowledge space. In this view, specific desired end-states (goals) are matched at a high level with features of the situation to identify an appropriate prepackaged, albeit abstract, strategy. The strategy is then instantiated in terms of the specific details of the problem/situation, and executed.

The organization of the expertise representation in COGNET is discussed elsewhere (e.g., Zachary, Ryder, and Hicinbothom, 1998; Zachary, Ryder, Ross and Weiland, 1992), and is not reviewed here. These expertise representation constructs are discussed in detail where appropriate in the following sections.

Interactions with the External World in COGNET

As should be clear from the preceding discussion, a COGNET model's interaction with the external world depends on both the internal processing mechanisms and the internal expertise. In fact, though, it is the internal expertise that is critical. Although it is the sensory capability that detects external cues, the information registered can only be internalized when there is some procedural knowledge available to internalize information about that cue in memory. Similarly, although it is the motor system that implements action, the overall system can only take those actions about which it possesses appropriate motor knowledge. Thus, without appropriate perceptual knowledge to allow the model to make sense of what it senses, or appropriate action knowledge to allow the model to manipulate the external world in a purposive way, the processing mechanisms are of no utility.

At a deeper level, the finiteness of a specific COGNET model places limits on its interactions with the environment. The way in which the patterns of demons are expressed, for example, must match precisely with the way in which cues are sensed and registered internal to the system. Even a slight “impedance mismatch” can result in information being lost or ignored. Similarly, the actions that the motor system attempts to take must match the affordances in the environment. Again, even a slight mismatch can result in actions not being successfully taken. This is clearly an artifact of both the way synthetic cognition systems work, and of software systems in general. They require the physical and data interface between the model and the external world to be engineered in a fairly precise manner. This has been a main concern in the development of the actual software system that implements COGNET, as discussed below.

This architecture has been shown as a useful basis for developing software systems that exhibit intelligent processing. However, the architecture, and by inheritance an application derived from it, is limited in its ability to do such things as

recover from interruptions, particularly when the application environment has changed during an interruption leaving the chain of reasoning and plan in progress at the time of the interruption partially of fully invalid;

manage competing demands for attention (i.e., deal with situations when the application environment activates multiple competing goals, such as “work as fast as possible” and “be as safe as possible”),

detect and manage internal conflicts, such as when separate parts of a plan are anticipating using the same resource in the action process for different purposes at the same time; and

respond to external direction to take an action or embark on a plan whose basis it does not understand.

The invention is motivated, in part, by the need to overcome these limitations.

The invention described here was also motivated by additional concerns about the pragmatics of the task of creating human behavioral representations for use in practical applications. Much of the prior work done to create integrated architecture for representing human cognition and behavior has been undertaken to a greater or lesser degree (and mostly to the greater) as exercises in psychological theory development. That is, models and frameworks were created to formalize, refine, and/or test specific psychological theories. The persistence of the frameworks over time has allowed increasingly detailed and refined theories to be formed. However, even though the result has been increasing verisimilitude, it has not been without cost. This cost has been seen in the increased complexity of the representations, which has increased both learning time and the difficulty in applying them to large complex naturalistic problems. In addition, the increasing complexity and level of detail has added to computational costs. On the other hand, as distributed constructive technology has become more powerful and evolved, the time (and budget) available for developing human behavioral representations has become smaller and smaller. Thus, a goal of the invention was to achieve the first goal in a way which increased, rather than decreased, the flexibility of the tool for practical applications, and which increased, rather than decreased, its overall computational efficiency and usability.

### SUMMARY OF THE INVENTION

In order to solve the above and other problems, according to a first aspect of the current invention, a method of simulating human behavior for interacting with environment, includes: defining resources that simulate the human behavior based upon resource definitions, the resource definitions defining at least cognition, sensory, motor and metacognition based upon attributes; representing certain internal aspects of the resources in symbolic knowledge; storing the symbolic knowledge in a predetermined metacognitive memory; updating the symbolic knowledge for each of the resources in response to any change that is related to the resources; and managing the resources for at least one cognitive task based upon the symbolic knowledge.

According to a second aspect of the current invention, a system for simulating human behavior for interacting with environment, including: an editor for defining resources that simulate the human behavior based upon resource definitions, the resource definitions defining at least cognition, sensory, motor and metacognition based upon attributes; a cognitive proprioception unit for detecting a change that is related to the resources; a symbolic transformation unit connected to the cognitive proprioception unit for representing certain internal aspects of the resources in symbolic knowledge; a metacognitive memory for storing the symbolic knowledge; and a metaconitive control unit connected to the metacognitive memory for managing the resources for at least one cognitive task based upon the symbolic knowledge.

According to a third aspect of the current invention, a computer program for providing real-time adaptive decision support, including: a predetermined set of resources for accomplishing a set of predetermined tasks; a cognitive module connected to the resources for executing at least one of the tasks, the cognitive module further including a cognitive scheduler, the task being defined by a task control declaration and being managed by the cognitive scheduler; and a metacognitive module operationally connected to the cognitive module and having a metacognition process control module, a metacognition memory and a metacognition scheduler, in response to the cognitive module the metacognitive module updating symbolic information on self-awareness of the resources in the metacognition memory in response to any change that is related to the resources, the metacognition process control module reordering the tasks in the cognitive scheduler based upon the symbolic information and the metacognitive scheduler module.

These and various other advantages and features of novelty which characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 is a diagram illustrating software modules of one prior art human behavior simulation system.

FIG. 2 is a diagram illustrating one data structure for the prior art human behavior simulation system.

FIG. 3 is a diagram illustrating one prior art human behavior simulation system.

FIG. 4 is a diagram illustrating one preferred embodiment of the metacognitive-capable human behavior simulation system according to the current invention.

FIG. 5 is a diagram illustrating one preferred embodiment of the metacognitive-capable human behavior simulation system according to the current invention.

FIG. 6 is a graph illustrating improved execution according to the current invention.

FIG. 7 is a diagram illustrating interactions between the cognitive layer and the metacognitive layer according to the current invention.

Table 1 is COGNET principles of operation.

Table 2 lists information stored in the metacognitive blackboard according to the current invention.

### DETAILED DESCRIPTION OF THE PREFERRED EMBODIMENT(S)

The current invention has generally focused on integrating and extending the COGNET and HOS architectures. COGNET is a cognitive architecture and software implementation developed in the late 1990s. It focuses on modeling real-time, multi-tasking human cognition at an expert level but in a minimally embodied framework. It has proven quite robust and flexible in capturing and simulating human strategies in complex environments such as Naval Command and Control (Zachary, Ryder, and Hicinbothom, 1998) and telecommunications operations (Ryder, Szczepkowski, Weiland, and Zachary, 1998), among others. However, the minimally-embodied nature of its representation made it difficult for COGNET to represent many sensory/motor aspects of human behavior necessary for realistic Computer-generated forces (CGFs). The Human Operator Simulator (HOS) is a performance modeling architecture and software implementation developed in the 1970's and 1980s (see Lane, Strieb, Glenn, and Wherry, 1981). It focuses on predicting highly embodied aspects of human performance in complex real-time work environments, such as eye-hand coordination in tactical tasks. HOS, however, was developed with only limited representation of cognitive processing. Thus, the opportunity existed to integrate the embodiment framework into the COGNET cognitive architecture, yielding a system with the strengths of both. Once integrated, the combined architecture could be further extended to incorporate additional representational capabilities. Because the general strategy has been to integrate HOS features into an enhanced COGNET, the result of these extensions is called CGF-COGNET.

Nine key characteristics according to the current invention are identified for a technology specifically created to represent human behavior in CGF's. This list is derived from various sources as well as the authors' experience in the field. The items in it are not advanced as the only key characteristics, but rather as important features that, at the start of this research, were not present in any single framework for creating HBRs in CGF:

1. Flexible granularity in behavioral and temporal representation—there is a need to generate representations of human behavior across the large spectrum of granularity in time and behavior. At the small-grained (low granularity) end, CGF simulations require the representation of the actions of elements such as individual dismounted infantrymen and/or individual weapon operators (i.e., ‘gunners’). These are roles in which low level physical movements and visual processes must be matched against terrain/environmental features in a very fine-grained manner, to simulate target identification, tracking and firing, complex physical movements such as crouching/hiding, even hand-to-hand combat. At the large-grained (high granularity) end, CGF simulations require representation of the strategic behavior of individual commander or even command posts. These elements may need minimal embodiment, needing only to provide command inputs and reactions as needed. From a temporal perspective, CGF simulations require representation of behavioral processes that range from small fractions of seconds, such as visual target tracking or manual control, to others that unfold over minutes, hours and above, such as command and control. Importantly, any given CGF simulation may involve processes across this full range of temporal and behavioral granularity, and thus the full range of possibilities should be realizable within same development/modeling framework. Equally important, the framework should allow the HBR to be constructed at close to the actual granularity level needed as possible, to minimize cost and effort of development.

2. Theory and component-model neutrality—As a corollary of the preceding point, the HBR development framework should not encompass specific psychological theories as elementary building blocks, requiring BR to be assembled upward from them. While it should permit the HBR to be constructed in this way, to force it would violate the goal of flexible granularity. Similarly, the HBR developmental framework should not require holistic theories when partial ones will do. For example, aspects of behavior such as visual search, manual performance, or even reasoning under uncertainty, may be highly important to some CGF applications (or specific HBRs within them), but not to others. Thus, requiring the same model to be used in all cases will eventually limit the flexibility of the system. Rather, an ideal HBF development framework should provide ‘affordances’, that allow component models based on different theories or data to be integrated on a case-by-case basis to achieve needed degree or flexibility. An added long-term value of this will be that it would improve the maintainability of the HBR. The ability to ‘plug and play’ component process models would allow the overall HBR to be more readily updated to reflect improved data and/or refinements of understanding of the component process without requiring larger changes in the remainder of the HBR model.

3. Real-time and multi-tasking attention behavior—An HBR development framework must be able to represent human behavior/performance in the real-time settings that are of primary importance to military contexts (and other civilian/commercial applications as well). Similarly, the HBR development framework must be able to represent effects of a very dynamic (battlefield) situation on attention and cognitive processes and sensory processes, and dynamic effects of manual/motor processes on environment as well.

4. Embodiment and Performance Realism—The HBR development framework must be able to represent the performance aspects of human behavior, such as errors, biases, physical limitations, etc. as well as competence aspects. Most of these performance effects concern the fact that human information processing occurs within the confines of human bodies, and thus the HBR development framework must ultimately deal with the situation-specific limitations that embodiment places on human behavior and reasoning. At the time, though, it must also be flexible in that regard, because various aspects of embodiment may be of importance in different simulations, as noted above under the discussion of flexible granularity. The limitations of human vision and visual perception, for example, may be critical to a realistic representation of an air-defense gunner, but of minimal importance in representing a ship's Tactical Action Officer. Thus, an HBR development must support embodiment and its limiting effects, but must not require every aspect of embodiment to be modeled when it is not relevant.

5. Inter- and Intra-Individual Variability—Human behavior is not constant, either for a single individual across many behavioral opportunities, nor across individuals in a population. Representing these types of variability is critically important in many CGF simulations. For example, a single model of a given role (e.g., pilot, infantryman, etc.) may be created, and then instantiated many times to create scale for the simulation. If all instances behave exactly the same all the time, the realism (and thus the value) of the simulation may be low. Rather, the different instances should be able to reflect the variation across the population, and each instance should exhibit some variability in its own performance over time. The HBR development framework must allow such inter- and intra-individual performance variability to be represented flexibly and constructively, so that it can be incorporated where and as needed, but ignored where not relevant.

6. Situational Effects/Moderators—Human performance sometimes exhibits specialized types of variability, typically degradational, under specialized conditions. These specialized conditions include extreme physical environments (e.g., very high/low temperatures, high or micro gravity), the presence of performance moderating factors (e.g., extended operations or sleep-deprivation, fatigue), and the presence of specific emotive factors (e.g. stress, fear). In some ways these effects are simply a specialized case of variability, particularly intra-individual variability. However, they require specialized representational structures, such as an awareness of certain aspects of the (simulated) self (e.g., time since last sleep, emotive state, warmth) and the relationship of these to a way in which information is processes and tasks are performed. An HBR development framework should allow these moderating efforts to be represented, ideally in an organic way that allows their effects to emerge rather than be simply externally predefined.

7. Team/Cooperative interactions—A main effect of having human complex systems, military and non-military, is their ability to work cooperatively and adaptively together, to form teams that create a whole that is more than the some of the individual parts. Highly scripted forms of HBR miss such aspects of human behavior as the ability to compensate for teammates' errors, the ability to change roles when and as needed, and so on. Paradoxically, the purely cognitive HBR models also often exhibit this same limitation, behaving optimally in an individual way, but failing to reason and act cooperatively. An HBR development framework should be able to generate cooperative and team behaviors, as well as individual reasoning/decision-making and environmental sensory/motor behaviors.

8. Usability—Ultimately, the sophistication of HBRs in future CGFs will have to be traded-off against the cost and time of developing them. This is becoming increasingly important, as advances in simulation of physical and mechanical systems is allowing other (i.e., non-human) parts of CGF simulations to be developed increasingly rapidly and cheaply. Thus, an effective HBR development environment, in addition to the above representational capabilities, must also possess a high degree of usability. Here, usability is taken to include the ease of developing, employing (stand-alone or federated), modifying, and maintaining an HBR for a given simulation. It also involves minimizing the prior knowledge (e.g., expertise in either tool or theory) and training needed on the part of the developer who is creating the HBR, and minimizing the effort required by that person to employ, modify, and maintain the HBR.

9. Execution efficiency and inter-operability—As CGF simulations move from research to operational training usage, there is an increased emphasis on the underlying economics of executing, maintaining and reusing existing simulations, including their embedded HBRs. The acceptance of the High Level Architecture (HLA) as an interoperability standard by IEEE has created an opportunity for maximum reuse of models, as well as well-defined inter-operability requirements. In addition to the enhanced representational capabilities and extended usability capabilities listed above, an ideal HBR development framework must be able to create HBRs that execute efficiently on widely available machines, and that can run as real-time components (federates) within HLA federations.

Integrating Frameworks to Meet Enhanced Human Performance Simulation Requirements

The relationships in Equation [1] indicate how human information processing could be decomposed (and represented) if one wanted to capture and predict, under essentially perfect circumstances, the kinds of problem-solving situations for which a person was competent. The analogy to linguistics is again useful. Linguistic competence refers to the ability of a person to understand and produce completely correct, fully formed meaningful utterances in a speech context. Thus, problem-solving competence refers to the ability of the person to understand a situation and produce appropriate, well-structured, interpretable, and goal-based behaviors as that situation unfolds. But just as most people rarely speak in completely correct, fully-formed sentences, so it is that individual problem-solvers seldom produce fully correct and optimal behaviors in any real world context. Even when the person has complete competence, in the sense of complete expertise, fully functioning processing mechanisms, and full access to the environment, other factors can cause actual behavior, which is termed ‘performance,’ to deviate from pure competence. These include factors of timing—the fact that processing mechanisms can require non-zero amounts of time to accomplish various functions—and accuracy—the fact that these mechanisms can function in a way which may sometimes deviate from the ideal. These observations suggest an extension of Equation [1] to create a version that focuses on performance, rather than competence. This is shown in Equation [2].

$$Individual Performance = processing mechanisms + internal expertise + external context + \qquad Equation [ 2 ]$$

time+accuracy

In terms of Equation [2], issues of individual differences and situational efforts/moderators can be viewed as elaboration's of the features which add time and accuracy constraints to underlying competence. The decomposition in Equation [2] provides a conceptual framework for creating the human performance simulation that is the goal of the present research. Because Equation [2] is an extension of Equation [1], the current invention proceeded similarly by extending COGNET to create a CGF-COGNET.

The competence level of CGF-COGNET consists of representations of the internal processing mechanisms, and of the internal expertise used in COGNET. The external context is defined on a domain-specific basis. The performance level adds additional constraining and limiting factors to these components, particularly to the internal components—the processing mechanisms and the expertise using representational concepts and constructs from HOS. On top of this hybrid structure, some additional features were integrated from separate research into computational metacognition in order to provide specific kinds of robustness and behavioral flexibility into the CGF-COGNET system.

By building on COGNET, the CGF-COGNET inherits its explicit focus on flexible granularity and theory neutrality. The conceptual extensions made to meet the other objectives are discussed below.

Time granularity—the nature of the complex work environments which COGNET and CGF-COGNET address unfold over periods of time which range from second to hours. This places them in what Newell (1990) called the “rational band” and the upper portions of the ‘cognitive’ band of temporal granularity. COGNET focuses on this range of granularity, eschewing constructs which operate at coarser and (particularly) finer levels of granularity, assuming that they are either too large or too small to have a direct influence on processes within the focal range. For example, it does not build cognitive processes ‘up’ from the low level memory operations (as, for example, ACT-R does) which operate in the range of less than 0.1 second, but rather focuses on activation of large chunked bodies of procedural knowledge (as discussed below). Here again, this is an as-if assumption, allowing the phenomena within the range of interest to be modeled as if they were independent of the lower and higher level processes and structures. For example, it is possible to implement an ACT-R-like structure within COGNET, but such a bottom-up approach is just not mandated.

Attention—the focus on representation and prediction in complex multi-tasking environments forces COGNET to deal explicitly with competing demands for action and competing opportunities to gain information, as well as constraints from the external environment on what can be done. Thus attention and the forces which shape it have been central concerns within COGNET from the beginning. There are two main concepts behind the COGNET approach to attention. The first is the notion of weak concurrence, which assumes that a person can actively pursue only one (high-level) goal at a time, although there can be many threads of goal-pursuing activity that are active at any one time. These threads may represent interrupted lines of reasoning, temporarily suspended ones, or even goals that the person knows are relevant but have not yet been activated. The fact that multiple lines of reasoning are being pursued simultaneously makes the processes concurrent, but the fact that only one of these is being actively pursued makes it weakly so. The second concept underlying attention in COGNET is the notion that attention emerges from primarily cognitive processes, rather being represented as a separate executive process. The fundamental concept of attention which COGNET has incorporated and greatly elaborated is the Pandemonium model first proposed by Selfridge (1959), which provides a representation of attention that is both weakly concurrent and emergent. At the same time, the pre-existing COGNET dealt with issues arising from recovery of interruption and suspension at a very coarse level. In large measure, this arose from the way that time was managed in COGNET, which minimized the opportunities for actual task interruption. However, these restrictions were removed in CGF-COGNET, and the need to incorporate parallel time-extensive processes in all three subsystems (motor, cognitive, and perceptual), substantially increases the opportunities for interruption. To deal with this, CGF-COGNET adds an explicit metacognitive mechanism for dealing with recovery from interruption and suspension.

Granularity-independent-embodiment—The need to represent the human role in complex environments has required COGNET to consider explicitly the physical mechanisms which link perceptual/action processes to the external environment. These physical mechanisms force COGNET to be an embodied cognition system (Gray & Boehm-Davis, 2000) in which the interaction with the external environment affects internal processes in a fundamental and on-going way. In CGF-COGNET, these interactions have become even more important drivers of the overall system performance. However, the time granularity of the overall system (seconds to hours) is to some degree inconsistent with the time granularity at which many of the effects of embodiment occur (microseconds to seconds). Thus, COGNET has adopted a granularity-neutral stance with regard to embodiment, allowing the modeler to incorporate constraints and features of the physical systems to the degree necessary and appropriate for the specific application. This is in contrast to systems such as EPIC, for example, which adopt a fixed (and relatively fine) granularity for the structure and processes of the embodiments of the system. The CGF-COGNET variant nonetheless seeks to more explicitly capture the constraining effects of embodiment. To permit this in a granularity flexible manner (in which there would be no fixed models of body features), the performance prediction approach of micromodels was adopted. This approach, which originated with HOS, uses closed form approximations of the time and/or accuracy constraints of specific physical instrumentalities in specific types of contexts (e.g., accuracy of reading characters of text; time to fingertip-touch an object within the current reach envelope, etc.). These micromodels allow existing experimental data and empirical relationships to be encapsulated and reused, but do not force any specific level of representation of body features in CGF-COGNET.

Expert-oriented knowledge structure—The COGNET focus on expert-level competence and performance in complex environments led to the representation of internal information in a manner as similar as possible to that used by human experts. In turn, this led to the incorporation of theories of expertise and expert knowledge structures that emphasize the efficiency and parsimony of expert decision processes, particularly in the real-time contexts where COGNET is focused. These theories (see Chi, Glaser and Farr, 1988; Ericcson and Smith, 1991; Hoffman, 1992), suggest that experts use highly compiled knowledge structures which minimize the process of searching complex knowledge spaces. These theories have considerable conceptual overlap with the notions of recognition primed decision-making, first suggested by Klein (1989), and the artificial intelligence concept of case-based reasoning (Kolodner, 1988). Although deriving from very different bodies of data, both of these suggested that context cues based on internal models of the external situation, allowed these compiled knowledge structures to be activated on a just-in-time basis in real-time settings. COGNET ultimately chose to incorporate all these concepts in its framework for representing the internal information or expertise held by the expert (see Zachary, Ryder, & Hicinbothom, 1998). At the same time, because the embodiment in COGNET was minimal, the level of representation of knowledge at the perceptual and motor level was quite minimal. The level of detail in the knowledge structures at these levels used in COGNET had to be expanded for CGF-COGNET. In addition, because the expanded embodiment created a much richer notion of time that was both continuous and discrete, as well as parallel across subsystems, the representation of knowledge about time and time-extensive processes also had to be greatly expanded in CGF-COGNET.

CGF-COGNET Principles of Operation

The structure and processing of information in CGF-COGNET is based on the COGNET principles of operation, which were listed in Table 1. However, most of these principles required a conceptual extension for the CGF-COGNET system. Below, each principle from Table 1 is discussed in more detail, both in terms of its original implication for COGNET, and then in terms of its extensions for CGF-COGNET.

Attention Focus Principle

The attention focus principle simply states one aspect of the concept of weak concurrence, by specifying that only one unit of procedural (goal-directed) knowledge can be active at a time. It also defines two properties of this unit of cognitive process execution:

that it represents a chunk (rather than an atomic unit) of procedural knowledge, and that the unit is called a cognitive task, and

that it can be in (at least) two different states—executing, and non-executing (the latter of which actually encompasses several different states, for reasons that will become clear later).

Thus, this principle begins (and others will follow) the process of defining the form of the internal information that is processed by the system. In particular, the notion that procedural knowledge is chunked into large units and executed in these units is consistent with the underlying models of expert decision processes discussed above.

Pattern-Based Attention Demand Principle

This next principle, as well as the following two, provide more definition for the way attention operates within CGF-COGNET and how knowledge is structured to fit within this process. To begin with, it defines a relationship between declarative information and procedural information. Specifically, it states that some combination or pattern of information in memory, simply by virtue of its existence, can result in a procedural chunk (i.e., cognitive task) changing its state from inactive to a new state which is termed active. The pattern or condition which causes this activation is incorporated within the cognitive task itself, and is termed the trigger. The trigger can be interpreted as a piece of metacognitive knowledge that ‘wraps’ the procedural chunk. Although it does not say it explicitly, the pattern-based attention demand principle implies that the process of comparing the trigger to the contents of memory is something that is done within the processing mechanism itself, as part of the cognitive process. In addition, this activation of large procedural knowledge chunks on the basis of broad patterns or context is a realization of the concepts of recognition primed decision making and case-based reasoning discussed earlier.

The principle further specifies that the active cognitive task vies for the focus of attention. This, in turn, implies that such an activated task does not necessarily have the focus of attention, yet it also is not inactive. Thus, this defines a third state of a cognitive task, besides executing and inactive, termed ‘active’. The process of attention can now be defined as the process by which tasks move from inactive to active to executing (and ultimately back again). The current principle only deals with the first half of this cycle, showing how a cognitive task moves from an inactive state to an active state (i.e., by its trigger being satisfied by the contents of memory).

Attention Capture Principle

This principle defines the other half of the attention process, that is, the mechanisms by which the focus of attention is allocated (and execution begins). The Attention Capture Principle clarifies this by introducing another metacognitive construct, the notion of a momentary priority of an activated task. Like the trigger, the priority is based on the information in memory at the current time. This suggests that the priority will vary as the contents of memory vary, an observation which applies to the trigger as well. Thus as memory changes (later principles will specify how that happens), a trigger may become ‘unsatisfied’ and the task inactive once again. Similarly, the priority may vary up and down as the contents of memory changes. When combined, the trigger and priority behave like the “shrieking demons” in Selfridge's Pandemonium model. As with the previous principle, the Attention Capture Principle suggests but does not explicitly state that the processes of evaluating the priority (constantly) and changing the focus of attention (when some cognitive task's priority exceeds that of the executing task) are organic to the cognitive process itself. Given that this is the case, however, the result is that attention emerges from the interaction of the changing memory contents and the metacognitive knowledge encoded in the triggers and priorities.

Task Interruption Principle

The previous principles leave unanswered the question of what happens to an executing cognitive task when another activated task captures the focus of attention before the first chunk of procedural knowledge has completely executed. This question is answered by the Task Interruption Principle, which adds yet another state that procedural knowledge chunks may assume—interrupted. It states that a task procedural chunk which has lost the focus of attention is in an interrupted state in which it continues to compete for attention. It is implied by the Pattern-based Attention Demand principle that this competition will continue only so long as the associated trigger is satisfied by information in memory. Similarly, the Attention Capture principle implies that the priority of the interrupted task may continue to change as the priority measure changes as information in memory changes. Thus, the interrupted task may regain the focus of attention if at some future time its priority exceeds that of the currently executing task. It may also re-gain the focus of attention if the currently executing task completes execution and the interrupted task is the only activated task or the activated task with the highest priority.

The Task Interruption Principle does not define what happens when an interrupted task resumes execution. In the standard COGNET system, the task resumes at the point where it was interrupted. This can, however, create problems in situations where the external world (and the internal representation of it) have changed substantially while the task was interrupted. As discussed below, metacognitive mechanisms have been incorporated into CGF-COGNET to support a richer set of means for adapting to recovery from such conditions when interruption and subsequent resumption occur.

Cognitive Process Memory Modification Principle

The previous three principles detail the relationship between the dynamics of memory and the attention process in both COGNET and CGF-COGNET. Specifically, they show how changes in memory can cause triggers to activate and deactivate procedural knowledge chunks, and how priority measures lead to some of these chunks gaining, and sometimes losing, the focus of attention. They do not discuss, however, the means by which memory can change.

The Cognitive Process Memory Modification principle begins by defining a unit of procedural knowledge within the cognitive task. This unit is called a cognitive operator. The principle also states that this lower level unit of procedural knowledge can, when executed by the cognitive processor, modify the contents of memory in some way. The principle implies that there can be more than one of these cognitive operators within a cognitive task, but does not define any additional details of the lower level components of cognitive tasks. In general, the changes in memory can be seen as the result of inferences of various sorts that are defined by the content of the procedural knowledge itself.

Although this principle is very simple, its implications are substantial for the system. On the surface, it simply states that a cognitive task can alter memory during its execution. However, given the linkage between memory contents, memory dynamics, and attention, this principle indicates that the attention dynamics are driven by the execution of cognitive tasks (although not exclusively so, as shown by the next principle). Thus, a chunk of procedural knowledge may, in the course of its execution, create changes in memory which may in turn lead to other tasks becoming activated and/or lead to changes in priority measures of active tasks that cause them to capture the focus of attention.

This principle therefore creates openness in the attention process, allowing any procedural chunk to make changes in memory that can allow any other chunk of procedural knowledge to become activated and/or to capture attention. The principle also provides a de facto granularity for the attention process. Because memory can be changed only as a result of execution of cognitive operators within cognitive tasks, this means that changes in the focus of attention can only occur after execution of a cognitive operator.

Perceptual Process Memory Modification Principle

The previous principle showed how cognitive processing can result in memory changes, driving the attention process forward in complex ways. Still, this process is in some sense closed, as memory can only be modified (thus far) by internal processes which are finite knowledge sources. Thus, even if there is some stochasticity in their contents, the possible set of changes and dynamics that can occur are bounded. More important, however, is the fact that it leaves memory, and therefore the cognitive subsystem, disconnected from the external world. This problem is resolved by the Perceptual Process Memory Modification Principle, which shows how the perceptual subsystem injects information that has been perceived about the external world.

This principle defines an entirely new type of procedural knowledge, called the ‘demon.’ This unit of procedural knowledge is executed by the perceptual process rather than by the cognitive processor. (As a result, the unit is sometimes called a “perceptual demon” rather than simply a demon). A key property of this unit of internal information is that it is self-activating, in response to a specific sensory cue. Thus, there is no attention process within the perceptual subsystem as there is within the cognitive subsystem. Rather, information is sensed and this sensation process (which can be thought of as registering external cues inside the system) leads organically to the activation and execution of perceptual demons that are able to process the information.

The principle also specifies what these units of procedural knowledge do when they are executed—they modify the contents of memory. It does not indicate whether there are any limitations to how many demons can be activated and executed within any perceptual processor cycle, nor whether there are any limitations to how many modifications to memory can be made in any time or cycle interval. In other words, there is no inherent bandwidth limitation to the perceptual process in COGNET. However, human sensory and perceptual limitations do create bandwidth constraints, and the CGF-COGNET variant therefore does provide some facility to represent these limitations (see below).

This principle complements the previous principle in showing a second way in which memory can be modified, i.e., as a result of information sensed and perceived from the external world. This adds much more complexity and openness to the dynamics of the information process, allowing flows in the focus of attention that can be driven either from reasoning processes (i.e., from memory changes resulting from cognitive operators) or from environmental perceptions (i.e., from perceptual demons). The latter type, in particular, allows for very abrupt changes in the focus of attention. For example, unexpected environmental information, such as hearing an alarm, can lead to abrupt shifts in attention to very different cognitive tasks.

This principle does not address any differences in time granularity between the perceptual and cognitive processes. While the previous principle implicitly set the granularity of cognitively-driven attention flows at the level of the execution of individual cognitive operators, the present principle does not indicate whether the memory changes resulting from perceptual process modifications occur at the same, lower, or higher level of temporal granularity. In practice, COGNET keeps the two processes at the same level of granularity. This is consistent with the large body of literature that shows these two processes as operating on the same time scale (c.f, chapter 2 of Card, Moran, and Newell, 1983.)

Multiple Task Instance Principle

This next principle deals with the abstract nature of cognitive tasks, and further details the relationship between procedural knowledge and declarative knowledge in COGNET. The main theme of this principle is that procedural knowledge may be defined in such a way that it operates on specific pieces of information in memory (called the scope), and that those pieces of information may be defined more abstractly within the cognitive task than they exist in memory. Specifically, the principle implies that items of information in memory may be specific instances of more general concepts or relationships (i.e., because they can exist in multiple instances), and that the items of information in memory may be represented in the cognitive task at this more abstract level. When this is the case, an instantiation process is required at the time the cognitive task is activated. This is a process of creating a specific instance of the cognitive task and associating it with a specific instance of information in memory on which it will operate. Thus, a chunk of procedural knowledge that is defined this way, (i.e., in terms of abstract specifications of information, specific instances of which may occur in memory) can be activated multiple times, either sequentially or simultaneously. Each of these activations is an instance of the cognitive task, and is bound to the specific instance of information in memory on which it will operate. The principle also indicates that these task instances, even though they all contain the same procedural knowledge chunk, are separate cognitive tasks from the perspective of the attention process and all other principles in Table 1.

This principle also provides some detail, although implicitly, on the organization of declarative knowledge in memory. Specifically, it implies that declarative knowledge can be structured hierarchically with at least two levels of abstraction. The lower level of abstraction is that level at which specific instances or declarative knowledge elements are placed in memory. The higher level of abstraction allows the same procedural knowledge to be applied to different instances of declarative knowledge in different contexts or multiple instantiations.

Task Suspension Principle

This principle adds one final state of cognitive tasks, a suspended state which results from ceding the focus of attention on a volitional basis. This principle defines the ability of the cognitive task to place itself in a suspended state and give up the focus of attention, while establishing a condition under which it will become re-activated and again compete to complete execution. The suspended state is in some ways like the inactive state, because a suspended cognitive task is not competing for attention and is awaiting some future state of memory in which a specific pattern is satisfied. Unlike an inactive task, however, the pattern here is not the overall trigger but rather a situation-specific pattern called the resumption condition. In other ways, the suspended cognitive task is like an interrupted task, because it has already had the focus of attention, executed to some internal point, and will continue forward from that point once (or if) it regains the focus of attention. In practice, the task suspension principle deals with chunks of procedural knowledge that are constrained by physical embodiment issues. For example, a thread of reasoning about a radar track may be highly chunked (and thus activated as a single cognitive task) but may incorporate points where the result of some external test or communication is required. In such cases, the cognitive task would be suspended until the needed information is established in memory, at which time the process could continue.

CGF-COGNET Information Processing Mechanisms and Architecture

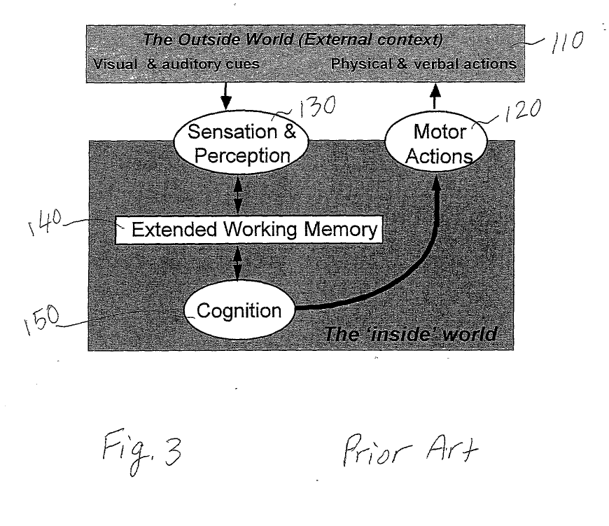

The information processing mechanisms within the pre-existing COGNET framework were shown in FIG. 3 above. The CGF-COGNET architecture builds on this by adding two major types of components:

sensory/motor resources 220, 230—which enable the simulation of time/accuracy constraints on physical interaction with the environment, and metacognitive components 250, 270—which enable more realistic management of both cognitive and sensory-motor resources 220, 230.

The detail of the metacognitive components further include:

1. cognitive proprioception: a set of software-based instrumentation that detects, on an instantaneous or near-instantaneous basis,

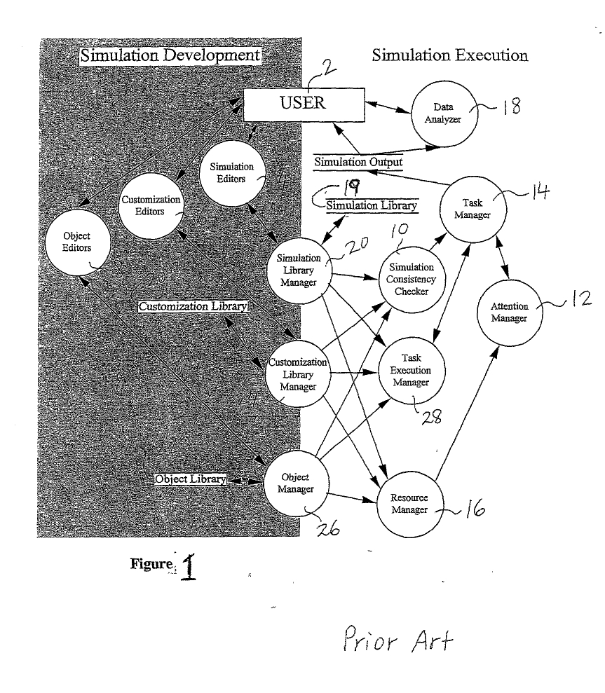

specific aspects of the operation of three processes shown in FIG. 1; and

usage and internal requests for usage of various resources within the system, including specific elements of knowledge, specific processing capabilities, and/or specific means of interacting with the external world (i.e., effects used by the action/motor process and/or sensors used by the sensory/perceptual process).

2. symbolic transformation and representation of the resulting state knowledge: a process that receives data from the cognitive proprioception process, transforms it into symbolic form, and places it into a metacognitive memory representation, which is accessible only to metacognitive controls, as described below

3. metacognitive processing controls—symbolic processing components which are activated on a proactive basis (i.e., in anticipation of some event or condition in the internal processing of the system, such as an approaching deadline), or a reactive basis (i.e., in response to some condition regarding the internal processing of the system, such as an interruption of one planning process by an unanticipated event). A metacognitive control can modify or direct the course of reasoning carried out by the cognitive process.

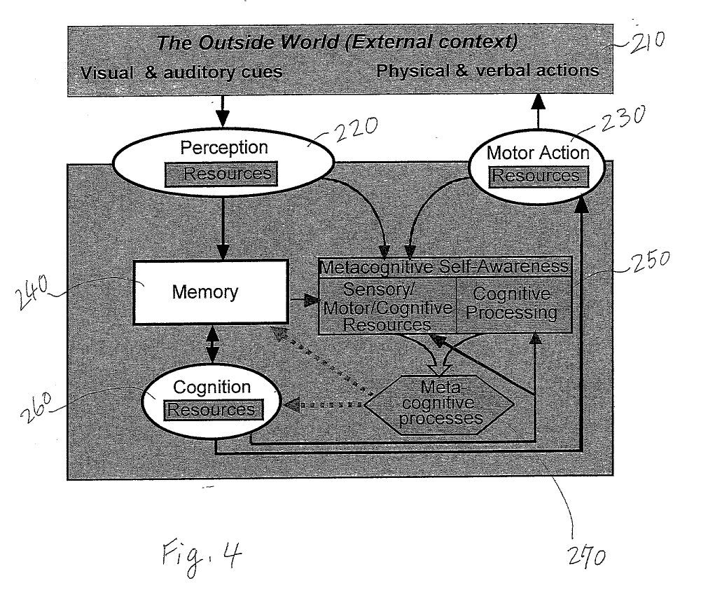

The resulting architecture of CGF-COGNET is depicted in FIG. 4. The functionality of the extensions are summarized in the subsections which follow.

Sensory-Motor Resources and Time-Accuracy Constraints

CGF-COGNET extends the information processing mechanisms in COGNET to support the representation and simulation of the time/accuracy aspects of sensory or perception system 220 and motor action system 230 performance in four primary ways.

1) It allows the creation of specific resources in each of the processing systems 220 and 230, but with particular emphasis in the motor-action 230 and perceptual system 220. Rather than pre-define specific resources at a fixed level of granularity, as for example done in Kieras and Meyer's EPIC (1995), the CGF-COGNET was designed to allow specific resources to be defined at a level that is appropriate for the purposes of the specific model being built. Resources can be defined to have attributes that allow them to be controlled. For example, eyes may have a point of gaze attribute, by which the eyes can be directed; that is, a deliberate eye-movement can be represented as replacing a current point of gaze with a new one. These attributes may also deal with the status of the resources, such as the ‘current business’ of a hand, or current use of the voice to complete an utterance. The ability to define resources allows CGF-COGNET models to be constrained with human-like limitations, in contrast to the undifferentiated (and unconstrained) sensory and action capabilities in the standard COGNET.

2) It modified the architecture to permit multiple, parallel execution threads in each of the three subsystems of the architecture (cognitive, sensory/perceptual, and motor). This allows independent processing activities to be executed in association with the different resources that could now be defined within a given subsystem. For example, the motor system 230 could control separate action process associated with a right hand, left hand, and voice, or the perceptual system 220 could receive sensory inputs from separate visual and auditory processes. The standard COGNET architecture, in contrast, permitted only one thread of activity in each of the main processing subsystems. In addition, CGF-COGNET allows some of the threads of activity in the sensory/motor subsystems 220 and 230 to operate either in parallel with cognitive processes 260 or linked with them. This allows, for example, a cognitive process 260 to directly control an on-going motor process 230 or to initiate it for ‘ballistic’ execution and then proceed in parallel.

3) It gave the ability to actually control the consumption of time on an execution thread. This enabled a thread of activity (and any associated resources) to become engaged in processes that occur over a period of time. The action processes in the conventional COGNET framework, in contrast, occur as events only, with no inherent time-extensiveness.

4) It added a micromodel construct. This construct, originally developed in the HOS system (see Glenn, 1989) allows context-sensitive invocation of a low-level model of the time and/or accuracy of a specific intended activity (motor or sensory) along any execution thread. The micromodel construct also enables the representation of moderators such as stress and fatigue (based on invocation context), as well as individual differences in performance.

Metacognitive Capabilities and the Management of Processing

CGF-COGNET also extends the cognitive architecture of COGNET to incorporate metacognitive capabilities. The term ‘metacognition’ in CGF-COGNET covers a range of functionality that:

gives the system a symbolic awareness of the state of its internal information processing,

provides the system with mechanisms to deal in a more complex manner with interruptions and conflicts among resources, and

enables the system to control the flow of reasoning within the cognitive subsystem based on features that are outside the scope of the COGNET principles of operation, such as temporal constraints or team/organizational needs.

Self awareness of resources and processes refers to the ability of CGF-COGNET to maintain an explicit symbolic representation of the cognitive processes being executed, of their execution status, and of the status (and plans for use of) various information processing resources that the current and planned (first order) cognitive processes will require. Such metacognition or self-awareness is a necessary condition for cognitive models to be able to intentionally modify these processes. It is also necessary for effective self-explanation. The self-awareness 250 is achieved with two extensions to the general COGNET framework. The first is an instrumentation of the information processing mechanisms, including the resources that are defined for a specific model. This instrumentation continuously gathers information on the status of all declared resources and their attributes, as well as on the knowledge being used in all processing subsystems. For the cognitive subsystem, this information includes the status of all cognitive tasks, which are either:

inactive,

active but not having the focus of attention,

active and executing (having the focus of attention),

interrupted (but still active), or

suspended

The symbolic information created and stored in a metacognitive self-awareness unit 250 by this instrumentation is then made available to the information processing system or metacognitive processes 270 through the second extension, a declarative metacognitive portion of memory which contains this information.

Interruption management and conflict management refer to the ability of CGF-COGNET to deal with various types of real and potential disruptions to its ability to act purposively. Potential disruptions may arise from two sources: conflicts stemming from the use of or need for specific resources, and conflicts which result from the interruption and resumption of cognitive tasks by the cognitive processor. For example, a cognitive task may be executing a line of reasoning about a specific object such as a radar track, triggered by its relationship (e.g., proximity) to another track. This task could be interrupted by some other more pressing activity, and when it resumes execution, the underlying relationship on which it was predicated may be fundamentally different. In the example, the two tracks may no longer be closing on each other but may now be moving apart. In such a case, continuing with conflict avoidance reasoning would be inappropriate. Detecting the existence of such changes in the mental model of the world is quite difficult, yet failing to do so dramatically degrades the quality and realism of the reasoning process model. Another type of conflict can arise because of the potential for multiple threads of independent activity. If one thread of motor activity is executing a complex motor task, it may intend to begin using one hand and later shift the focus to another. However, a second, independent thread may have already begun execution using the other. Detecting such a conflict is similarly difficult. And in this case as well as the previous task-interruption case, detecting the conflict is only half the problem. Once detected, a way of resolving the conflict must be generated as well.

The second set of metacognitive extensions in CGF-COGNET provide mechanisms to deal with these conflict detection and resolution processes. These extensions build on the first set of metacognitive extensions, specifically on the self-awareness which provides the basis for detecting conflicts. The conflict management functionality is accomplished through the introduction of procedural knowledge that is purely metacognitive in nature, in that its main purpose is to control the execution of first order cognitive processes, primarily by detecting and avoiding conflicts. These metacognitive procedural knowledge chunks are termed controls, to differentiate them from cognitive tasks. Controls can be triggered in a variety of ways, based on self-awareness information and possibly other information in memory as well. The types of controls and triggering conditions include:

deadlock controls, which are triggered when two threads of activity are contending for a resource and the contention is causing each to be ‘locked out’, and which when triggered resolve the deadlock according to the procedural knowledge they contain;

proactive controls, which are triggered by some potential conflict such as an expectation of insufficient time to perform a cognitive task, and which modify execution of the task in some way to attempt to avoid the conflict;

interruption/resumption controls, which are triggered when a specific cognitive task is about to be interrupted or resumed, and which can alter the processing of the task to accommodate a smoother interruption (e.g., by forcing completion of some activity or reasoning process) or a smoother resumption (e.g., by detecting changed information which may affect task processing, and then determining how the change is to be accommodated).

The procedural knowledge incorporated into controls is a superset of that which can be incorporated into cognitive tasks. Specifically, controls have access to the self-awareness information in the metacognitive memory, and they are able to execute those metacognitive operators which are extensions of the normal COGNET operator set. Metacognitive operators are able to manipulate the aspects of the metacognitive memory which are associated with the flow of attention among the first order processes, such as the priority of a specific cognitive task. This allows metacognitive controls to effectively manage the flow of execution as a way of resolving resource conflict and/or interruption-driven conflicts.

CGF-COGNET Expertise Framework

The representation of internal expertise used in COGNET is maintained in CGF-COGNET, with two additions:

metacognitive expertise—units of knowledge used to control the selection and execution of procedural knowledge, and

metacognitive self-awareness 250—units of declarative knowledge about the status of the information processing system itself and the various processes in which each component is engaged.

In COGNET, the only types of metacognitive knowledge are the triggers and priority measures of cognitive tasks, and they are actually incorporated in the cognitive task itself. However, in CGF-COGNET, as discussed above, there are separate metacognitive mechanisms and thus separate metacognitive expertise components. Specifically, there is the declarative metacognitive memory (i e., self-awareness), and procedural metacognitive knowledge (i.e., the various metacognitive controls and operators).

Additional extensions to the low-level representation of expertise were added in CGF-COGNET to deal with the representation of:

motor and perceptual processes, particularly time-extensive aspects, and variations in time and accuracy, and

separation of processes into sequential versus parallel threads (e.g., differentiating motor and thought processes which are interleaved from those which are parallel).

These expertise representation constructs are discussed in more detail, where appropriate, in the following sections.

Software Support for the Model-building Process

Ultimately, a COGNET or CGF-COGNET model is expressed as a piece of software that simulates human competence or performance in a specific domain. Over the last five years, the COGNET research team at CHI Systems has developed a software environment to support the building, execution, testing and application of COGNET models This environment consists of several components. The main component is the software engine that emulates the internal processing mechanisms and functions according to the principles of operation discussed previously. This engine is called BATON (Blackboard Architecture for Task-Oriented Networks). Much of our recent research has consisted of implementing the revised architecture and principles of operations into a CGF-COGNET version of BATON.

The BATON engine executes a body of domain-specific expertise (i.e., the expertise model) via interaction with a (real or simulated) external problem environment. The expertise model is represented in two different forms in the COGNET software environment. BATON itself operates on a highly formal representation of the expertise description language. This executable version of an expertise representation is called the COGNET Execution Language or CEL. While CEL can certainly be read and authored by people, it requires some substantial programming skill. To reduce this need for programming knowledge, a graphical programming interface to CEL was created. This is the CEL Graphical Representation or CGR, and is the primary means by which users of COGNET software interact with the expertise model. The translation between CEL and CGR is done automatically and continuously by underlying translators. The CGR software is written in such a way that changes in the CEL syntax and semantics are directly translated into appropriate graphical renderings in CGR. Thus, only very minimal changes to CGR were necessitated by CGF-COGNET. In contrast, major effort was involved in modifying BATON to correctly process the revised semantics of CEL and to follow the CGR-COGNET principles of operation. These changes are described in the following sections.

### PERFORMANCE MODELING FEATURES OF CGF-COGNET

The CGF-COGNET extends COGNET functionality and integrates HOS functionality in several ways. CGF-COGNET allows:

the explicit representation of physical resources such as sensory resources (eyes, hands), and/or motor resources (hands, voice),

the ability of each of these resources to engage in time-extensive activities that are independent of each other, and also independent of the time-extensive activities of the cognitive and perceptual processes as well;

the psychomotor resources to be engaged in activities that are tightly coupled with cognitive processes, allowing strict interleaving of activities across these three subsystems (e.g., look, think, act, perceive, think, etc.).

the factors which determine the time-required to complete a time-extensive task to be separately modeled and simulated in a way that represents inter- and intra-individual variance;

the factors that determine accuracy in motor and sensory actions to be separately modeled and simulated in a way that represents both inter-and intra-individual variance; and

the effects of memory degradations, such as decay and mis-remembering, to be explicitly represented and simulated.

Multiple threads of activity in CGF-COGNET

The concept of a ‘thread of activity’ can have different interpretations. The idea of having multiple threads of activity in CGF-COGNET is to allow many activities to occur concurrently. In one sense, the pre-existing COGNET already had multiple threads of activity, in that several tasks could be started (i.e., be active or interrupted) at any particular time. The Attention Focus Principle of operation specifies that the cognitive process is executing, at most, only one cognitive task at a time. As the attention switches from one task to another, more than one activity can be initiated and carried on over with a time sharing of the cognitive resources. This is, in a sense, very similar to what operating systems do to handle multiple threads or processes while sharing a single processor.

This kind of multi threading of cognitive tasks is, however, different from the kind of multiple threaded activity that must occur across the perception process, the cognitive process, and the action motor process in a performance modeling framework. In this case, all three must truly proceed in parallel. Modeling this with a “Von Neuman style” (i.e., single processor) computer requires some adaptations to emulate this parallelism within the single-instruction/single-datum framework.

The solution employed in CGF-COGNET is to employ a time-sharing approach at a different level, making an explicit distinction between the concepts of simulated time and real time. While all threads must share the real time in a single processor architecture, they may each use the processor simultaneously in simulated time. For example, an activity in the perception process and another one in the cognitive process that would each require one second of simulated time, would still require one second of simulated time to execute both. In contrast, two one second activities in the cognitive process would require two seconds of simulated time to comply with the attention focus principle of operation.

In the pre-existing COGNET, it was not possible to spend any simulated time in the perception and motor action processes without also expending time for the cognitive process as well. The consumption of time was exclusively handled via the Suspend_For operator, which could be executed within cognitive tasks only. The Spend-For simply consumed time to emulate the length of time which a cognitive process required. It could not be used in Demons nor in motor actions. The net effect of this was that all perceptual and motor actions were executed in a single atomic time-step. Thus, no other activities (i.e., cognitive activities) could take place within the atomic interval in which the perceptual and motor processes were activated, executed, and completed. Thus, there was not a way in which to simulate parallel motor, cognitive, and perceptual processes in COGNET, particularly in the case where each unfolded on a different temporal thread.

CGF-COGNET introduces a new threading mechanism that allows a perception and motor activity to be performed over any arbitrary amount of simulated time within their own processes. In practice, this means that Suspend_For operators can be executed within perceptual demons. This allowed a demon to function as a perceptual process rather than just as a perceptual event. (The question of how much time such a process should consume is discussed later in this section under micromodels.) For motor processes, a more complex structure is required. A new operator has accordingly been introduced: Action, which allows a definition of an action within the symbolic model in contrast to the Perform_Action operators that are calling C++ functions in the shell.

Unlike the cognitive process that allows only one active thread of activity at a time, the perception and motor action processors allow any number of threads of activity in parallel. For example, two or more Actions can occur simultaneously (from a simulated time perspective), or two or more demons can be running concurrently. Two instances of the same demon can also be active at the same time. Sensory limitations are handled by the perception resources rather than by limitation to a single active instance of a demon at a time.

Spending Time in Activity Threads

The key aspect of multiple threads of activity and performance modeling in general relies on the ability to represent an activity that occurs across an interval of time, i.e., a process rather than an event. This will be referred to as “time consumption” in a thread. As noted above, using the operator Suspend_For in a demon allows this existing construct to be used to represent a perceptual process that is consuming simulated time. However, the conceptual meaning of a Suspend_For operation within a cognitive task is different. When a cognitive task instance suspends itself, it explicitly relinquishes the focus of attention, implicitly allowing other cognitive task instances to capture it through the Attention Capture Principle. Thus, the suspended task is not actually consuming any simulated time. Imagine, for example, the case where three cognitive task instances are competing for attention. The one with the highest priority is executing until it suspends itself for one second. The one with the next highest priority becomes active until, for example, it too suspends for one second, which lets the third one to execute. If the third also eventually suspends itself for one second, then all end up being suspended. After one second of simulated time elapses, all three will once again compete to regain the focus of attention in the order corresponding to their respective priorities. The point is, however, that although three cognitive task instances were suspended for one second, only one second of simulated time was actually consumed. In a sense, they were actually running in parallel, much as an operating system executes parallel processes on a single processor.

To obtain true time consumption, a cognitive task instance must keep the focus of attention. In standard COGNET, this was achieved with another operator, Suspend_All_For. Unlike Suspend_All, this operator would not only suspend the current Task instance but all cognitive task instances, thus preventing any other cognitive task instance from gaining the focus of attention. This manipulation, however, presented some problems. First, it violated the Attention Capture Principle. Even when all cognitive task instances are suspended, Demons can still be activated and change the memory content. As priority formulas have access to the memory content, one of the suspended cognitive task instances could have legitimately captured the focus of attention but would have been prevented from doing so, as all task instances would have been suspended. Second, the Suspend_All_For operator also prevented any new task from being triggered, thus violating the Pattern-based Attention Demand Principle. Third, even after the cognitive task instance resumes from the suspension, it is allowed to keep the focus of attention until the next reschedule, even if it does not have the highest priority of all the active tasks. Another operator, Suspend_All_Until, that offers a conditional suspension instead of time-based suspension, presented the same problems.

Spend_Time Operator

The CGF-COGNET corrected these problems by replacing the operator Suspend_All_For by a new operator: Spend_Time, which keeps the focus of attention only as long as the task instance has the highest priority. With this solution a new task can be triggered as soon as a demon is activated and changes the memory content.

Time is consumed in the simulated execution thread in which the operator Spend_Time is located. In this respect, it is similar to a suspend operator. It was initially thought to specify the time consumption in the metacognitive ‘headers’ of Tasks, Goals or Methods (at the same level of the trigger condition for example). A time consumption could have been specified for an entire task or for individual goals at various levels of abstraction. There were, however, two problems with this solution. First, when specifying time consumption for an entire task or goal it was not clear where the time should actually be spent: at the beginning, at the end, or spread uniformly across the goal or task. None of these solutions seems satisfying. Second, a conflict could easily arise when time consumption was specified for both a task and its goals. The sum of the times for each goal could be different than the time for the task. The problem would have been the same with a goal and its nested goals.

For these reasons, the Spend-Time operator described above was chosen. Many spend time operators can be used in a task, spread across different goals at different levels of abstraction. Time will actually be consumed only if a spend time operator is encountered in the execution path. A spend-time in a goal whose precondition is not satisfied will not be executed. The time actually spent by a task is rarely the sum of the time specified in all the Spend-Time operators contained in the task. It varies depending on what part of the task is actually executed. Additionally, this approach supports a flexible granularity in modeling time consumption. A highly detailed approach could incorporate a constructive approach to time consumption at a very fine level, partitioned by the lowest level function being performed (e.g., each memory recall, each reasoning operation, each goal activation, etc.) and consuming time only as each atomic unit actually occurred. At the other extreme, the consumption of time across relatively high-level units such as subtasks or groups of goals could be estimated with a single spend-time operation, allowing crude but much simpler representation and management of time consumption.

The Spend-Time construct was also used in the new Action and Perception Function operators, discussed below.

Spend_Time_Until Operator

A new Spend_Time_Until operator was also added to replace Suspend_All_Until. This operator is very useful to express that a task will be spending time until a particular condition is satisfied. An example of such a situation would occur for example for a task that describes scanning the horizon. The core of the task could be simply implemented with a Spend_Time_Until where the condition will be the appearance of an object in the field of view. The scanning task could be interrupted at any time by a more important task and would resume scanning implicitly.

The Spend_Time_Until operator can also be used with an optional time-out feature that stops the time consumption if the resuming condition has not been satisfied within the specified time. If a time-out occurs, a set of instructions associated with the time-out are executed. This is useful to differentiate a time-out from a normal resumption. It also provides the opportunity to specify an alternative behavior if the resumption condition is not met. The Suspend_Until operator has also been modified to incorporate the new time-out feature.

Continuous Time Increments

In standard COGNET, the external shell specifies the (simulated) time increment. The time is set periodically to a new value (either on a fixed ‘tick’ or on a variable ‘tick’) thus creating a discrete time increment, consistent with the underlying discrete event nature of the system. However, this solution is not appropriate for CGF-COGNET because the extensions described above make it possible for a thread of activity to consume a unit of time smaller than the time increment given by the shell. When a Suspend_For operator is used, the task is suspended until the time becomes greater than the time at the suspension plus the suspension time. Even if the suspension time is much smaller than the time increment, the suspension would be at least the time of the external time increment. This is particularly problemmatic when modeling perception time or fine grain motor actions.

A new timing mechanism was developed in CGF-COGNET to solve this problem. It relies on maintaining two times in parallel: the external simulation time as given by the shell, and an internal simulation time incremented by the time consumption in the model. Basically the internal time plays a ‘catch-up’ game with the external time. The model is allowed to execute only to the point where the internal time catches up with the external time. It then waits for the shell to increment the external time again. With this solution, spending less time than the external time increment would simply advance the internal time but would not actually stop the task. The cognitive task will only be stopped when sufficient time consumption has occurred to allow it to catch up with external time. This solution allows taking into account infinitely small time increments, even if the shell time increment is one second or one minute. In a sense, it represents a continuous time increment, or its best approximation.

Handling Real-time Operations

By definition, a real time system is a system that can react within the appropriate time The appropriate time depends on the application and can vary from a few milliseconds or less to hours or days. For modeling human behavior, experience has shown that time resolution down to a few tenth of seconds is usually sufficient. We assume that external time updates represent real-time updates. The ability to meet this requirement depends on how much the internal time is allowed to run behind the external time. For example, external time update requests are stored in a queue in COGNET. Time updates from the queue are only processed once the internal time has reached the external time. If it takes too much time to catch up with the external time, then external time update requests will pile up in the queue and the internal time will lag more and more behind. This is particularly important when, for example, the external simulation is part of a federated environment that includes real people and simulated entities interacting in real time. Without some ability to adapt to real time operation, the model could begin to get more and more out of synchronization with the external world.

The time it takes for the model to catch up with the external time does not really depend on how much simulated time (specified with the Spend_Time operators) is consumed by a cognitive process or perceptual demon. Running a Spend_Time operator simply advances the internal time but does not require virtually any real-time. Rather, the place where ‘real’ time consumption occurs is in the executable operations within the cognitive tasks. How fast these instructions can be executed depends on the speed of the processor and the efficiency of the execution engine. What really matters is the ratio of instructions to the amount of simulated time consumed. An abstract performance model could have a fairly low ratio while a very detailed model would have a higher ratio. Performance models are also more likely to fare better than competence models, as the introduction of Spend_Time operators tends to spread the computational load over simulated time. It may also have some positive effect on the modeling practice. A competence model that is not constrained by simulated time consumption would tend to apply a comprehensive and computationally time consuming analysis of its input. A performance model that acknowledges the time it takes for humans to process input data will implicitly reduce the analysis complexity per time unit. Thus, allowing Spend_Time operations at variable levels of detail not only supports flexible granularity in modeling, it also supports flexible time-management for different types of simulations.

There is a factor that may be even more important than raw speed to provide real-time performance: the ability to adapt to time pressure. In the case of CGF-COGNET, this consists of making sure that the queue of pending time updates remains within acceptable limits. For this purpose, CGF-COGNET has given the modeler and shell developer the possibility of checking the number of external time updates in the queue and the total amount backlog time. With this information, it becomes possible to implement a metacognitive process within the model and shell that adapts the level of detail and complexity of the treatment to the performance of the platform on which the model is run. Creating such an adaptive shell and metacognitive model can, however, be a complex undertaking.

Hyper-real-time and Simulation Environments

Fortunately the models that have been tested so far with CGF-COGNET were not too ‘greedy’ and never let external time updates accumulate in the queue. The overall efficiency of the execution engine is still important for various additional reasons. First, more than one model may be running on a single machine. Second, it may be possible to run the model at speeds faster than real time in a simulated environment. In this respect, the new timing mechanism of CGF COGNET allows a model to be run in conjunction with a simulator at the maximum speed that the processor will let them run. Better yet, this mode provides the optimum precision in terms of synchronization between the simulator and CGF COGNET, as follows: Each party allows the other party to run for up to a given amount of simulated time. The other party may use all this time or only a part of the allocated time. In any case, at the end of each cycle a party provides some data and specifies an amount of time up to which the simulated time is allowed to advance. In our case, the simulator provides input data and the model provides action data. The simulation and the model take turns one after the other. They never run at the same time, which is best when running both on the same machine. On the COGNET side, when an external action is encountered, the model stops at the first Spend_Time that follows. It then sends action data to the simulator and lets it run for the amount of time specified by the Spend_Time¹. In turn, the simulator may consume all the allocated time or return earlier with input data. The simulator would specify its own time increment as the next allocated time. This is simply treated as a normal external time update. The only difference from the normal execution is that the model does not always run until the internal reaches the external. It will stop earlier if an action is performed. This technique guarantees complete synchronization between the simulator and the model, with a potentially infinite level of time granularity. It also allows execution at the maximum speed allowed by the computer. This can be much faster than real-time or slower than real time. In any case, the behavior of the model will be identical. It is, of course, always possible to slow down the execution to make it work at exactly real-time. CGF COGNET is fully equipped to support this mode of execution, which has been used for the Amber project. It requires, however, a similarly compliant simulator to obtain the best result. ¹ It would actually take the time until the next scheduled event in the scheduling. It would be the time in the next Spend_Time only if the model was single threaded.

Ballistic and Non-ballistic Actions

Actions are executed on the motor-action processor. It is noted that the term ‘processor’ is taken loosely here, as several actions can occur simultaneously on the motor action processor, such as a right hand movement and a left-hand movement. In fact, not all actions are necessarily executed on the motor action processor. Two types of Actions are possible in CGF-COGNET: ballistic and non-ballistic. A ballistic action is performed on the action processor, in parallel with the cognitive processor. It models a physical action which can proceed simultaneously to the cognitive thread which initiated it. For example, an action to turn off a warning buzzer can be initiated and completed in parallel to the reasoning process that may continue to think about how to respond to the warning. In contrast, a non-ballistic action is one which essentially “locks up” the reasoning thread that invokes it. An example of this may be a menu-reading task, in which the visible portion of the list is read, and then stopped while the hand is used to depress a button to display the next page of the list.

This distinction was not represented in the previous version of COGNET. Rather, all actions were ballistic, which frequently caused problems when trying to model activities (like the example given above) which were essentially non-ballistic. In CGF-COGNET, a non-ballistic Action is performed on the same processor from which it was invoked and controlled, sharing its simulated time with the invoking process. For example, if a non-ballistic Action is invoked by a cognitive task, the simulated time used by the Action will be attributed to the cognitive task and will prevent any other cognitive task from executing while the action is performed. A ballistic Action would let the calling cognitive task continue to spend its own time.

An action, whether ballistic or not, can be invoked from within another Action. This is useful for supporting the flexible granularity of representation in the motor system. Unlike the prior COGNET, Actions in CGF-COGNET can now incorporate a hierarchy of goals, just as for tasks and methods, allowing further flexibility in the representation of action processes.

Modeling Time/accuracy of Actions Using Micromodels

As noted above, the concept of micro model was integrated into CGF-COGNET from HOS. A micro model is a self-contained formalism (which may use parameters tied to the context in which the micro model is applied) which can be used to predict or model parameters of a sensory or motor action, such as its time or accuracy. When modeling time, a micromodel is typically used in conjunction with a Spend_Time operator; the micromodel estimates the time needed to complete the action or perceptual process, and the Spend_Time actually implements the consumption of that amount of time. Four initial micromodels were constructed to demonstrate the concept and support the various demonstrations of the CGF-COGNET system thus far in the project. These four are summarized below functionally:

Eye Movement Time (from Glenn, Schwartz, and Ross, 1992, Using Data from Dodge & Cline (1901):

Define_micro_model eye_movement_time.

Specify old_direction and new_direction in radians.

Let D=difference of old_direction and new_direction

Then eye_movement_time=0.01432*D+0.0175 secs.

Hand Movement Time (from Welford, 1960, and Drury, 1975, and Fitts & Peterson, 1964, and Card et al, 1983)

Define_micro_model hand_movement_time

Specify distance to move hand and target_size in the same units

Then hand_movement_time=0.1*log2(0.5+distance/target_size)secs.

Digit Reading Time, (from O'Keefe, 1976)

Define_micro_model dial_digit_time

Assume that this is just the reading time for a digital numeric display for easily legible characters where the only variable is the number of digits in the number.

Then set dial_digit_time=0.12*number_of_digits secs.

Walking Time (from Clark, 1967)

Define_micro_model move_person_time

Specify distance_in_meter

Assume normal pace walking.

Then move_person_time=0.62*distance_in_meter secs.

Eventually, it is anticipated that a much larger library of micromodels will be created and integrated within CGF-COGNET to support performance modeling.

The micromodel syntax is currently similar to the syntax of the Determine construct already in COGNET. Micromodels can have access to declarative memory information, including self-awareness information (see Section 5 below). A micromodel can, for example, access the self-awareness of the current position of the hand or eyes stored in the metacognitive blackboard, and calculate a time/accuracy prediction based on that information.

Long-term Memory in CGF-COGNET

Modeling memory plays an important role accurately modeling human performance. Phenomena such as memory decay or forgetfulness are interesting concepts. Our effort so far has only concerned modeling long-term memory. The blackboard in COGNET represents the extended working memory. In CGF COGNET, we have introduced the concept of a long-term blackboard. It shares the same definition as the normal blackboard but has different content. Memory elements (called hypotheses in our case) must explicitly be moved from the blackboard to the long-term blackboard and vice-versa. Two new operators have been created for this purpose:

Memorize—copy an hypothesis from the Blackboard to the long-term Blackboard, and

Remember—copy an hypothesis from the long-term Blackboard to the Blackboard.

However, a reference to the hypothesis is actually to copies and not the hypothesis itself. The consequence is that any modification of an hypothesis in the blackboard also affects the corresponding hypothesis in the long-term blackboard. A hypothesis cannot be retrieved directly from the long-term blackboard; it must first be copied in the Blackboard. The intent of the long-term Blackboard is to store long-term information and not to be used as a working memory.

The long-term Blackboard can be loaded and saved from and to a file separately from the Blackboard. This allows COGNET to save what has been learned during a session and to load it again at the beginning of the next session.

The distinction between working memory and long-term memory is a first step toward implementing memory moderation mechanisms. It would be possible to implement some mechanisms that would affect only the working memory, like for example, a delay mechanism that would remove or alter an hypothesis after a certain amount of time. A small time consumption may also be associated to the remembering operation to model the time required to retrieve information from the long term memory.

There is another advantage to differentiate long-term memory from working memory. The long-term memory is intended to store a large quantity of data which is not modified very often. This opens the possibility to use an internal data structure that favors fast retrieval time but with slower writing time. Implementing the long-term memory with a conventional database is also interesting, as it would be usable directly by other applications and could be manipulated easily outside of the modeling framework. The Memorize and Remember operators would keep the same syntax, thus making the interaction with the database completely hidden.

### METACOGNITION

Metacognition refers to the process of “cognition about cognition.” If human cognition is viewed as the representation and processing of information internal to the person, then human metacognition refers to that internal information and those internal information manipulation processes that focus on human cognition. In more colloquial terms, metacognition is how people think about and control their thought processes. To make this more concrete, consider the following situations:

1) A member of an operations team in a command post finds his workload rapidly growing in the current tactical situation and, fearing that he will soon not be able to do everything that he knows he should, begins to think of ways to drop or defer some tasks. He is aware that there is an automation mode in his system that can automate processing of a different set of his current tasks. He initially wants to hand off some of his work to the computer, but thinks about the computer's ability to do the tasks, and concludes that the job might not get done adequately by this automation and would be hard to monitor. He also notes that there is another member of the team who is less experienced but is not overloaded, and thinks that he might hand off another subset of his work that could be assigned to that person. Even though he concludes that the job might not get done adequately by this relative novice person, he also concludes that he can easily monitor what the nearby teammate is doing, particularly if the teammate is told to call out his intentions along the way, allowing the off-loaded work to be monitored at a high level and quickly taken back if necessary.

2) A watchstander in a shipboard combat information center has just noticed a new track on the tactical display and needs to make an initial assessment of its ID, intent, etc. As he begins this task, however, he notices that several other tracks have appeared that also need assessment, and that he needs to provide some direction to some of the subordinates on his team. Judging that there is not enough time available to go through his typical new-track assessment process, he chooses instead to do a very minimal version of the process, checking for obvious immediate threat characteristics and, finding none, moves on to other things, making a mental note to review the track in more detail as soon as possible.

In the first case, the person with the high workload has to be aware of the various tasks that are competing for his attention, to project how the tactical situation might affect these in the future, and then make a decision about his ability to perform in such a future situation. The person also makes assessments about the ability of other members of the team, both human and automated, to perform some of those same tasks, and about how he or she might maintain some degree of control over those tasks even after they have been handed off These kinds of behaviors require the ability to examine one's own mental processes, but this time not retrospectively but concurrently and even prospectively, and to compare them to (mental models of) the processes of other people and machines. It also requires the ability to understand the interconnection among tasks (such as knowing whether and how some might be shed to others), as well as to observe the performance of those tasks and evaluate their effectiveness even when being done by others.

The second case describes a situation where the individual has to be aware of his intended thought process and project it into a future situation, make judgements about the time required to complete the thought process and possible effects, and modify the thought process on the basis of those judgements. Here again, these kinds of behaviors require the ability to step outside the thought process and reason about how that process is likely to play out in a larger problem context, and in this case to modify the process itself as a result

These examples point out key behaviors that require metacognition—an awareness of internal information processing and an ability to manipulate and manage those processes in the same way that ‘ordinary’ (or what will here be called ‘first order’) cognitive processes manipulate and manage representations of the outside world. The behaviors involved in the examples are representative of flexibility, adaptability, and creativity that people bring to complex environments. Metacognition can be seen as a critical enabler of cooperative and adaptive human behaviors, including self-explanation, teamwork, dynamic re-tasking and function allocation, and command and control, among others.

The CGF-COGNET extends COGNET functionality and integrates and extends prior synthetic metacognition research in several ways. Specifically, CGF-COGNET allows:

metacognitive self-awareness, via

instrumentation of the information processing architecture, and

declarative memory for self-awareness information

resource declaration and control mechanisms

interruption and recovery infrastructure and management

The representation and extent of self-awareness, both organic and application/model-specific, is discussed. The mechanisms and infrastructure for defining and managing aspects of knowledge and individual processing mechanisms as resources is discussed. Finally, the mechanisms that provide for much greater interruptability and more natural interruption recovery are discussed These mechanisms build on both the self-awareness and the resource management functionality. More complete discussions of the architectural framework are given below.

Metacognitive Self-Awareness

The first question, of course, is what information does the ‘self’ need to be aware? From a cognitive perspective, there are two key classes of information:

state of the information processing mechanisms (e.g., perceptual, cognitive systems, working memory) and sensory/motor resources (e.g., eyes, hands, etc.), and

state of the internal information being processed (e.g., what tasks need to be done? What information is activated in working memory, etc.?)

The next question, then, is how might this self-awareness be built in a synthetic cognition system? A useful way to conceptualize this self-awareness is as the possession of declarative knowledge about the information processing system itself. However, unlike other types of declarative knowledge, this metacognitive declarative knowledge arises neither by perception of the external world nor by active inference on internalized information, although the process more resembles the former of these. Rather, the declarative self-awareness information arises from a mechanism for sensing the system's own internal processes, what can be called cognitive proprioception. To create this cognitive proprioception in a synthetic cognition system such as CGF-COGNET, then, it was necessary to ‘instrument’ the internal mechanisms and knowledge elements and identify a formal representation for the resulting declarative knowledge.

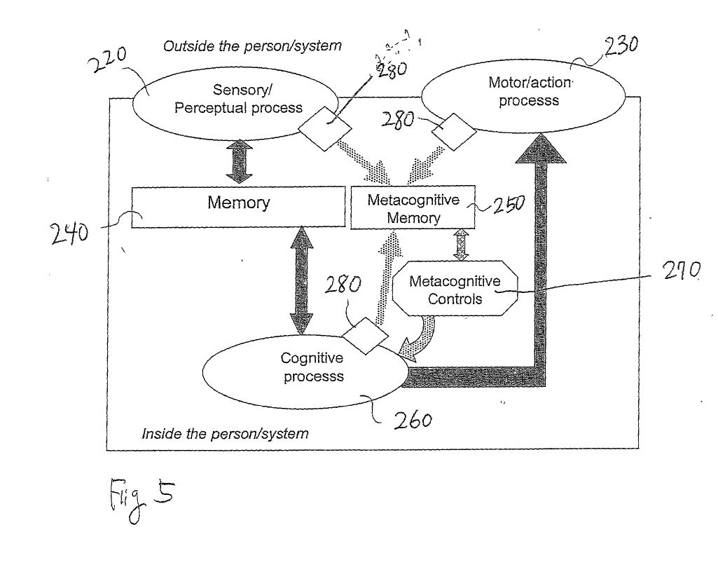

Within both COGNET and CGF-COGNET, declarative knowledge is represented using a blackboard structure or memory 240, in which individual declarative concepts, called hypotheses, are placed in an abstraction hierarchy. Referring to FIG. 5, this same structure provides a suitable framework for capturing the information on the system's self-awareness. Unlike the usual declarative knowledge blackboard (which is structured in a domain-dependent manner), the resulting metacognitive blackboard or metacognitive memory 250 has both a domain-specific and a predefined structure, the latter corresponding to the categories of self-awareness information discussed above for internal information and for underlying information processing mechanisms. Information placed in this metacognitive blackboard 250 in CGF-COGNET by proprioception mechanisms (i.e., measurement instruments) 280 that detect the processing status information and post it on the metacognitive blackboard 250.

Once created by this cognitive proprioception process, the self awareness declarative knowledge obtained is maintained as the content of a special blackboard in CGF-COGNET called the meta-cognitive blackboard 250. This blackboard has a predefined Panel (named Model), that provides information about the current activities of the cognitive processor 270. It also allows for definition of any number of domain-specific panels defined by the model-builder for a specific HBR.

The predefined Model panel contains three levels: Task, Task Instance and Model, as follows:

Task: Every hypothesis in the Task level represents a Cognitive Task in the model. The attributes of each hypothesis provide information about the execution of the Cognitive Task. Each hypothesis at this level is linked to its current Cognitive Task Instances on the Task Instance level.

Task Instance: Hypotheses in the Task Instance level are associated with the current instances of Cognitive Tasks. Each Task-Instance hypothesis has a link corresponding to the hypothesis that represents its Cognitive Task type on the Task level.

Model: The model level contains a single hypothesis whose attributes represent general information about the model.

All the hypotheses in the predefined panel are created, modified, and removed automatically by the cognitive proprioception mechanisms. The information on this panel can be accessed by the first order cognitive processes (e.g. Cognitive tasks and Perceptual demons), but not modified. It is not possible, for example, to use a transform operator on these hypotheses to modify an attribute or link value. Table 1 summarizes the contents of the Model panel of the metacognitive blackboard. The details of the attributes at each level are discussed below.

The Task Level

Each hypothesis of this level represents a Task of the model. They are all created statically at the beginning of the model execution but their attributes and links are updated during the execution. Their attributes provide quantitative information about the processing of various pieces of knowledge during the execution of the model. The specific attributes are:

Name: the name of the Task. This makes the high-level goal that is the task name accessible to reasoning processes.

Number of started instances: number of time the Task has been instantiated, including the instances currently active.

Total time spent: cumulated time of all the time spent in all the instances of the Task, including the current instances.

Number of interruptions: number of times that all the corresponding Task instances have been interrupted by other Task instances in result of a change of the focus of attention Note, this does not count the number of times when a ballistic action or a demon is allowed to run during a spend time of the Task instance.

Number of suspensions: number of times the corresponding Task instances suspended themselves (with a suspend_for or suspend_until operator).

Number of Goal execution: the number of goals executed for all the instances of the Task. This gives an indication of the complexity of the part of the Task that is being executed.

Number of Determine calls: number of times a determine function has been called while executing the corresponding Task instances.

Number of Method calls, Number of Cel actions calls, Number of Ballistic actions calls, Number of Micro model calls, Number of Calculate calls, Number of C++ actions calls: these attributes are similar to the number of determine calls but for a different kind of function.

All the attributes in the Task level provide information for the total execution of the task which represent the sum of the execution of all its Task instances. Average values per Task instantiation can easily be calculated by dividing the total values by the number of started instances.

The Task Instance Level

Each hypothesis in this level represents an instantiation of a Cognitive Task. A new hypothesis is posted in this level any time a new Cognitive Task instance is triggered, and is unposted when that task instance is completed. Each hypothesis is linked to the hypothesis of the task it instantiates on the Task level. This link, as any link, is bi-directional, so it can be used to find all the current task instances of a particular Task, as well as the general task of which the current task is an task-instance Hypothesis at this level have the following attributes:

ID: provides an identification number as it is displayed during debugging. This number also provides information about the order of the task instances. For example, an id number 3 indicates that this is the third instantiation of this Task.

Priority: the current priority of the task instance as calculated by the priority formula of the Task. The priority is recalculated any time there is a significant change in the blackboard or when the time changes.

Status: the current status of the Task instance. At any time a Task instance can be Triggered, Active, Interrupted, Suspended, Interrupting or Resuming.

Context: the context in which the task instance was triggered. The context is used to differentiate Task instances of the same Task. It is specified by the task_instance_context parameter of the Task. It usually indicates on what the Task is working on and is typically one or several hypotheses.

Trigger Time: time at which the Task instance was triggered.

Activation time: time at which the Task instance gained the focus of attention (became active) for the first time and started to execute.

Time spent: time spent by the Task instance (as consumed by the spend_time operators) since it became active. Note, the time spent may be less than current time—activation time if the Task instance has been interrupted.

Remaining time to spend: if the Task is currently spending some time, it indicates the time that remains to be spent. If it is not currently spending time, then the remaining time to spend is 0.

Number of interruptions, Number of suspensions, Number of Goal execution, Number of Determine calls, Number of Method calls, Number of Cel actions calls, Number of Ballistic actions calls, Number of Micro model calls, Number of Calculate calls, Number of C++ actions calls: are all similar to the corresponding attributes of the Task level except that they are counting the occurrence during the execution of the Task instance and not total execution of all the instances of the Task.

The Model Level

This level contains a single hypothesis that contains general information about the model. Its attributes are as follows:

Name: the name of the level.

Time Spent: the total amount of time actually spent executing by the model. The model is considered spending some time when at least one Task, one ballistic action or one demon is spending some time through the usage of a spend time operator. However, when two or more threads are spending time in parallel (for example two demons, but not two Tasks as only one Task is active at a time), the spent-time is counted only once. The total time spent is therefore different from the sum of all the spent time in the model.

Shell queue size: indicates the number of elements currently in the shell queue. The shell queue stores all the demon invocation and time update requests in the order they were received. These requests are then consumed during the execution of the model as the internal advances to catch up with the external time. This mechanism has been described elsewhere in Section 4. The size of the queue is an indication of how well the model is keeping up with the flow of data coming from the external world. This information may be used by metacognitive processes to modify the level of complexity with which the data are processed to increase the speed of the processing. Ideally, the queues should remain as small as possible or at least not contain more than one time update request.

Shell queue latency: the difference between the time of most recent time update request entered in the queue and the current time. This a direct indication of how much time a model is running behind the real world. To ensure a good response time, it should be as small as possible.

shell queue next time update. the next external time update that will be obtained form the shell queue. As the model is always catching up with the internal time, there will always be a next time update as long as the model is currently executing. If the model has already caught up with the external time (it has consumed the last external time update from the queue), then it is waiting for the external time to advance and is not processing any instruction.

Collecting Additional Measures in the Metacognitive Blackboard.

The automated Model panel contains a variety of information, but other information could potentially be collected as well. For example, other levels could be added to provide self-awareness of motor actions, perceptual actions, or other aspects of lower level cognitive processing (e.g. via Method, Determine, Calculates, and Micromodel constructs). The function calling information currently expressed with attributes could be expressed with links so it would be possible to know exactly what action is being called by what Task. One of the problems with this approach is the potential execution overhead of maintaining all this information. The current solution consists of creating a new hypothesis for each Task. Creating systematically a new hypothesis for each function call would be too penalizing. A creation only on demand, when metacognitive level is currently being researched, could be a solution in future versions of CGF-COGNET. (It is noted that maintaining the attributes values does not assume any overhead as they rely on a different mechanism than regular hypotheses.)

User Defined Metacognitive Panels

In addition to the automatically maintained Model panel, the modeler can define additional model-specific metacognitive panels and levels. They do not functionally differ from conventional panels and levels but they are intended to store information related to self A good example might be a metacognitive blackboard panel/level that is dedicated to the storage of information on sensory/motor resources, such as eyes and hands; storing such attributes as direction of gaze (for eyes) and hand positions (for hands).

CGF-COGNET does not specify how the eyes or hand movement are modeled but rather provides a set of mechanisms, especially related to the timing and resource management, to implement these models. It also has the structures needed to reuse models of these resources, via libraries and reusable code. In the future, we plan to develop and provide these kind of sub-models as libraries which future model-builders would be able to use. Importantly, different versions of these body models can and should be developed representing different levels of granularity and functionality. Future modelers should be free to directly reuse or to modify one of these, or to create totally new representations as best fits the needs of the model being built. This is driven by the goals of flexible granularity and theory neutrality stated above.

Another example of user defined metacognitive panels could be to store information related to emotions or physiological/psychological status such as fatigue, time-without sleep, stress, etc. Like the vision or hand models, they could later be implemented as reusable model libraries that would combine some panel or level definitions and a set of functions that would automatically update them as the circumstances evolve.

Workload Self-assessment

The information on the metacognitive blackboard can be used to provide the model with the ability to be aware of its own workload state, on several different dimensions. Using the CGF-COGNET software, a human behavioral representation was generated for the Air Force as part of its AMBR program (Zachary, Santarelli, Ryder & Stokes, 2000). An important capability of this model was the ability to produce workload self-reports using NASA's TLX measurement scales, which include measures of perceived effort, perceived temporal demands, perceived physical demands, perceived mental demands, perceived success, and perceived frustration.

The information in the metacognitive blackboard was used to produce separate dynamic self-assessments (using a user-defined metacognitive workload panel) of each of these six measures. It should be noted that other models of the same Air Traffic Control Task being developed using other HBR frameworks (ACT-R/PM, a SOAR/EPIC hybrid, and a new framework called D-COG) were unable to produce anything but single aggregate measures, while the CGF-COGNET model was able to generate all six measures. Importantly, the workload self-perception can be used to modify task processing strategies, providing a dynamic metacognitive feedback onto primary task performance, a characteristic missing in prior HBR models.

Resource Mechanisms

A major by-product of ‘embodiment’ of cognitive models arises when two or more (cognitive) processes try to use the same (sensory or motor) physical body part. This was a major issue in CGF COGNET development; the conflict arises when, for example, two ballistic actions try to use the same hand at the same time. Fortunately, this problem has a well-studied analog in computer science, where shared access to resources in parallel systems is a well-known problem. When two processors try to access simultaneously the same resource, for example a disk drive, a conflict arises as only one processor can really use the disk at any time. One of the processors has to wait until the other has finished its atomic action to proceed. In CGF-COGNET, the technology used to solve the shared access problem in computer science was used to craft a solution to the shared body part problem. Specifically, CGF-COGNET solves this kind of problem by preventing any internal process from accessing a ‘resource’ that is already in use by ‘locking out’ additional attempts to use the resource. This required development of mechanisms to declare features of a model as resources and to enable the locking in/locking out process. These are discussed below.

Declaration of Resources

The first aspect of the resource locking mechanism is the declaration of the resource usage. To be able to use a resource, a knowledge element must first declare its intent to do so. A knowledge element in this case can be a Task, a Goal, or a Method. A special option in the CGF-COGNET syntax allows the user to declare the usage of the resource at the beginning of the definition of the knowledge element. A resource is currently represented as a hypothesis in the metacognitive blackboard. The attributes of the resource store all the information related to the status of the resource. For example, the ‘eyes’ resource may have a ‘direction of gaze’ attribute. Resources can be declared for read-only usage or write usage. When in read-only mode, other Tasks or knowledge elements still have read-only access to the resource, but not write access. Conversely, a write mode will protect against any read or write access. The reason is that when intended to be modified, the actual status of the resource may not be known or coherent until the end of the modification. A read-only access on the other hand does not affect the resource. This distinction prevents from blocking a resource when it is not necessary without compromising the level of protection.

More than one resource can be declared simultaneously; for example, two hands or the eyes and one hand. This capability is actually very important to reduce the probability of deadlock situation as described below.

Locking Resources

Once a resource is declared, it acquires a lock protection that lasts for the entire duration of the execution of the knowledge element in which it was declared. When the resource is declared in a goal, for example, the resources will be locked at the beginning of the goal and released at the end.

Locking mechanisms are prone to a well-known problem: deadlock. A deadlock situation can occur when two different threads try to access two resources. Typically, when thread 1 acquires resource A and tries to access resource B while still holding resource A, and when at the same moment, thread 2 has already acquired resource B and tries to access resource A. This kind of deadlock situation can actually involve more than two threads and resources, as long as they are caught in a circular dependencies pattern.

When a deadlock occurs, all the threads involved are stuck indefinitely until at least one of them releases the resource it holds. Detecting a deadlock situation by itself is not easy, especially when a larger number of threads is involved. CGF-COGNET has implemented a special mechanism to detect deadlock situations and let the model specify a remedy when it occurs.

The deadlock detection mechanism was actually the main motivation for implementing the resource locking mechanism. If not for the deadlock, a simple attribute in the resource hypothesis could indicate whether the resource is being used or not. By simply testing for the value of the attribute and changing its value to “used” while using it would do the trick most of the time. Unfortunately, under this scheme, it would be almost impossible to detect a deadlock situation and resolve it.

When a thread attempts to use a resource, if the resource is already locked, the thread will be suspended until the resource becomes available. More precisely, the status changes to a new status: waiting for resources.

Current Limitations of Resources Locks in CGF-COGNET

The locking mechanism described above works well for simple threads like ballistic actions and demons. When used with Tasks, the situation is more complex. For example, imagine a Task, read_book, that requires the eyes resources and another, speak_to_someone, that also require the eyes resource. With the current mechanism, if the read_book Task is interrupted by the speak_to_someone Task, speak_to_someone will actually suspend itself immediately because read_book has locked the resource it needs. As a result, read_book will simply continue and prevent speak_to_someone from executing. It may be the result expected in some situations but probably not in the example above.

To solve this problem, a cognitive task should not be allowed to keep a resource locked if it loses the focus of attention. When that occurs, however, another problem arises when that cognitive task resumes from its interruption—the current state of the resource is likely to be different from what it was before the interruption. Then again, it is not clear whether systematically releasing the resource when interrupted is the appropriate thing to do. The locking mechanism could have been used to prevent the cognitive task from being interrupted.

Another limitation arose from associating the duration of the lock to the execution of a Goal or a cognitive task. When two resources are acquired separately, their acquisition and releases cannot be intertwined. For example, the following scenario is not possible. Acquire A, acquire B, release A and release B. Only acquire A, acquire B, release B, release A or Acquire A, release A, acquire B, release B are possible. The solution would be not to tie the duration of a lock to the scope of a Goal or Task, but this would require an explicit lock release that would be more error prone but also more difficult to implement.

Finally, nothing currently prevents the access to an hypothesis that just appears to be used as a resource by another cognitive task. The modeler must have the discipline to always declare these hypotheses for resource usage whenever they want to access them. The solution to this might be simply to create a special type of hypothesis that could not be accessed with conventional CEL operators. While being difficult with the current blackboard structure, future evolutions of the Blackboard concept could make the implementation of such a specialized hypothesis type easier.

For the two first issues discussed above, CGF-COGNET currently limits the usage of resource locks to simple cases in ballistic actions. The example models developed to date tended to use locks for short hand movements or voice control (e.g., to allow finishing an utterance before beginning another one). These simple cases never put the deadlock mechanism fully to the test, as more than one resource was never acquired at a time.

Metacognitive Controls

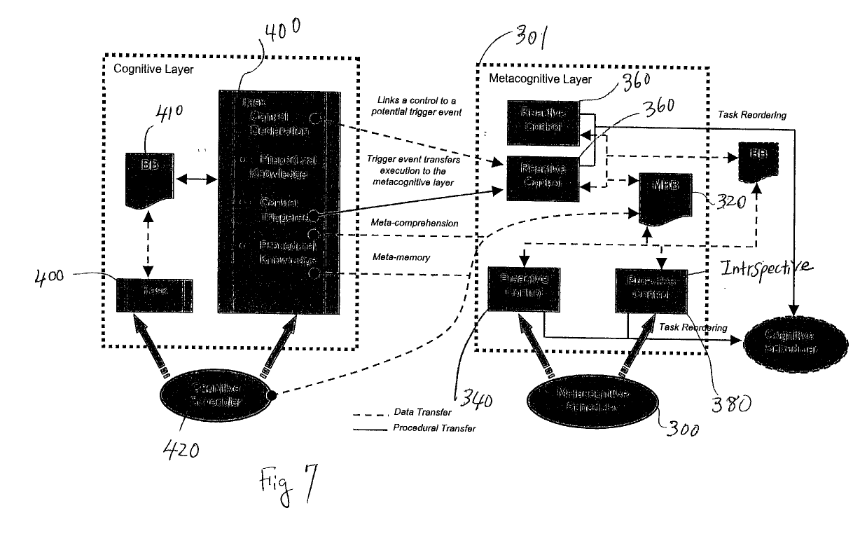

Referring to FIG. 7, the cognitive proprioception instrumentation and metacognitive blackboard (MBB) 320 provide a dynamic symbolic representation of the content of the problem solving processes being undertaken by intelligent software application based on the generic architecture of FIG. 1. The symbolic knowledge in the metacognitive blackboard is put to use by reasoning procedures called metacognitive controls. These metacognitive controls 300 use information in the metacognitive blackboard 320 to adapt the reasoning processes of the application to factors other than the problem being solved, including, (but not limited to) the:

levels of workload being experienced;

complexity or depth of processing in the face of on-coming deadlines or approaching work demands;

effects of resumption of some task or tasks after an interruption, during which the external application environment (or internal processing demands) has changed; or

problems associated with interlocking demands for a common resource within the system.

The invention provides for three types of control processes—proactive control 340, reactive control 360, and introspective control 380. Several types of reactive controls are provided directly, while other reactive controls and all proactive and introspective controls are developed for each specific applications using domain specific knowledge. The symbolic knowledge used in all controls is clearly procedural in nature, defining the reasoning dynamics that are used to control the primary cognitive process. Metacognitive controls 340, 360 and 380 are activated on the basis of situational appropriateness, either in response to some situation (reactive or introspective) or in anticipation of some situation (proactive). However, unlike cognitive tasks, these metacognitive procedures are not triggered by the state of the external world (as contained in primary system's memory), but rather by the state of the cognitive system which includes a task 400, a blackboard 410 and a cognitive scheduler 420 (as contained on the metacognitive blackboard 320). The three classes of metacognitive controls provide different functions, as detailed below.

Reactive Controls

The reactive control 360 is triggered by the occurrence of a specific event on the metacognitive blackboard. Various types of controls are needed to react to different classes of events. The usage of reactive controls involves two different specification processes:

1) control definition—where the procedural knowledge in the control is defined via as a stand-alone definition, analogous to Methods and Determines; and

2) control declaration—where it is specified what control should be used, where and under what condition depending on the type of control.

A control declaration is specified in through the use of On . . . set of operators. This declaration can be placed glabally (i.e., as a separate process) or be embedded within a cognitive task where it may affect that execution of it. A declaration placed within a cognitive task in this way remains available to be triggered as long as the cognitive task is active, while a globally declared control is always available to be triggered.

Three types of reactive metacognitive controls are available in COGNET. Each type corresponds to a particular event in the cognitive layer 301. These events are:

interruption—activated when a cognitive task is in the process of being interrupted by another;

resumption—activated when a cognitive task is suspended or interrupted and is in the process of being resumed;

failure—a cognitive task has “failed” to achieve its goal. That this is a domain-dependent failure state, which must be explicitly defined within the expertise medel; and

sustainability—a cognitive task has resumed execution after interruption or suspension, and its assumptions about the external situation need to be reassessed.

Each is described separately below.

Interruption and Resumption Controls

The Task Interruption Principle of Operation in COGNET and CGF-COGNET dictates that cognitive tasks may interrupt each other. While this makes sense from the point of view of modeling human behavior, it also introduces its own set of potential problems from the computational side. Once a cognitive task starts to execute, it implicitly assumes that certain conditions are satisfied. For example, at the beginning of execution, it assumes that the condition(s) that triggered the cognitive task are (still) satisfied. During execution, subordinate goals may specify, through their preconditions, additional implicit conditions. When a cognitive task is interrupted, there is always a risk that the declarative memory blackboard is going to be modified by the interrupting cognitive task (or sequence of tasks). This can result in a situation where the implicit conditions for execution of the interrupted cognitive task no longer hold when that cognitive task resumes its execution. For example, a cognitive task that concerns talking to someone may assume there is someone there to talk to; in fact, the presence of a person may have triggered the task in the first place. When resuming from an interruption, it may be important to make sure the person has not left the room in the meantime. This type of problem assumes much greater importance in CGF-COGNET because of the enhanced mechanisms for spending and consuming time within cognitive tasks and actions.

While type of consistency management is an inherent property of human cognitive processing (and thus seemingly effortless), it is, in fact, extremely complex and requires substantial additional processing in a synthetic cognition system. In CGF-COGNET, this additional processing is managed by interruption and resumption controls.

Reactive controls define the ways in which the processing of a specific chunk of procedural knowledge must be modified upon interruption/resumption. Thus, these controls must be defined, in theory, for each piece of procedural knowledge they affect. In practice, they can be defined at the beginning of any chunk or subchunk of procedural knowledge: a Task, a Goal, a Method or a non-ballistic Action. The control is executed when a knowledge chunk to which they are associated is interrupted or resumed. For example, if an interruption control is defined for a Goal, whenever an interruption occurs while executing this Goal the interruption control will be executed. If an interruption occurs within a nested Goal of this Goal and also has its own interruption control, then only the most local control will be executed (in this case the one of the nested Goal).

Conceptually, the function of an interruption control is to identify the implicit assumptions about execution of the procedural knowledge (at that point forward). Similarly, the function of a resumption control is to compare the actual state of declarative knowledge at the time or resumption with the implicit conditions, and then decide how the procedural knowledge chunk is to continue, (e.g., continue unaffected, return to current goal, return to beginning, give up, etc.). Thus, in the ‘talk to someone’ example given above, an interruption control might simply note that the presence of the person talked-to is necessary. After looking away because of an interruption, the interruption control might simply check to make sure the person is still there, and continue the dialog (or perhaps return to the prior question/statement) if they were, and terminate the task if they had left.

As seen above, resumption controls can be used to check if the current declarative memory (i.e., blackboard) contents are still compatible with the resuming cognitive task. Interruption controls also can be used to prepare for a smooth resumption after interruption, and take physical and cognitive actions that can help maintain the consistency when resumption occurs. For the Task read_book, for example, the interruption control could also initiate actions to put in a bookmark and put the book away, prior to relinquishing control to the interruption task. In this example, the resumption control would open the book again. Because physical actions are involved, these two actions should not happen instantaneously but be allowed to consume some time. The ability to consume time within an interruption control could also be used to simulate the time it takes to switch the focus of attention. Consuming time, however, opens the possibility for an interruption to occur while executing the interruption control. Allowing time to be spent in the resumption control would of course have the same effect. Such possibilities, unfortunately, open up additional potential problems.

The simple solution of simply doing nothing about it may not be desirable in some cases. For example, consider the use of a ‘spend time’ operation in a resumption control to express how much time it takes to restore the cognitive context when resuming a Task. If an interruption occurs during the resumption control, when the Task resumes, it should resume the execution of the resumption control. If half the time of the resumption control had already been spent at the time of the interruption, then only the remaining half will be spent after the resumption. That would not represent accurately the time for the switch of attention. In this case, it would be more appropriate to restart the resumption control. The solution of always restarting a resumption control may not work however when modeling the resumption of the read_book Task. Here it may be better to resume the resumption where it left. In any case, it is difficult to predict what would be the best behavior under any circumstances. One possible solution considered was to specify a resumption and interruption control for interruption and resumption controls that consume time. Those second order controls themselves would not be able to consume time, thus removing any need for third order or more controls.

Another solution that avoided second order controls was to make the interruption and resumption controls uninterruptible. This would, however, violate the attention capture principle of operation, as the Task with the highest priority might not be allowed to run. Alternatively, it would require modification of the principle, e.g., to apply to first order procedural knowledge only and not metacognitive knowledge. In either of these cases, though, there is surprisingly little cognitive data on which to base a design decision. This observation, in fact, extends to much of the metacognitive area. Additional data on human cognitive processes in this type behavior (interruption processing and management) is clearly needed. Lacking such data, however, a compromise solution was taken. Rather than strictly forbidding interruption or creating second-order controls, it was decided simply to recommend that the model-designer increase locally the priority of the interruption or resumption control to minimize the likelihood of its interruption. It should be noted here that the interruption controls implicitly “borrow” the priority of the interrupting cognitive task. They can therefore only be interrupted if a Task with an even higher priority occurs. Besides this implicit priority boost, it is possible to override locally the priority of a control with a local override_priority_formula parameter. For example, putting a bookmark in a book should have a high priority. Only exceptional circumstances should interrupt such a small operation. In practice, choosing a priority would almost guarantee uninterruptibility but will still comply with the attention capture principle of operation.

These controls are usually used in pairs and facilitates the recovery from interruption of a cognitive task. Conceptually, it is a way of representing a small unit of procedural knowledge that will be activated any time a cognitive task is interrupted (interruption control) and resumed (resumption control). These procedures determine how the first order procedural knowledge (i.e., the cognitive task being interrupted) is to continue execution. More specifically, these reactive controls define the ways in which the processing of a specific chunk of procedural knowledge must be modified upon interruption/resumption. Thus, these controls must be defined, in theory, for each piece of procedural knowledge they affect. In practice, they can be defined at the beginning of any chunk or subchunk of procedural knowledge. The control is executed when a knowledge chunk to which they are associated is interrupted or resumed. For example, if an interruption control is defined for a Goal, whenever an interruption occurs while executing this Goal the interruption control will be executed. Van interruption occurs within a nested Goal of this Goal and also has its own interruption control, then only the most local control will be executed (in this case the one of the nested Goal).

Conceptually, the function of an interruption control is to identify the implicit assumptions about execution of the procedural knowledge (at that point forward). Similarly, the function of a resumption control is to compare the actual state of declarative knowledge at the time or resumption with the implicit conditions, and then decide how the procedural knowledge chunk is to continue, (e.g., continue unaffected, return to current goal, return to beginning, give up, etc.). For example, if an application is an intelligent agent that is interacting with a user (e.g., via voice synthesis/recognition), and is interrupted to perform some other task, it needs to ascertain, upon resumption whether the person is still there. In this case, an interruption control might simply note that the presence of the person talked-to is necessary. After diverting attention to some other task because of an interruption, the interruption control might simply check to make sure the person is still there, and continue the dialog (or perhaps return to the prior question/statement) if they were, and terminate the task if they had left.

As seen above, resumption controls can be used to check if the current declarative memory (i.e., blackboard) contents are still compatible with the resuming cognitive task. Interruption controls also can be used to prepare for a smooth resumption after interruption, and take physical and cognitive actions that can help maintain the consistency when resumption occurs. For the Task read_book, for example, the interruption control could also initiate actions to put in a bookmark and put the book away, prior to relinquishing control to the interruption task. In this example, the resumption control would open the book again.

Sustainability Controls

When a cognitive task has been interrupted by another cognitive task, the blackboard content may have been modified by the time the interrupted task resumes its execution. Unfortunately this is not the only case where the execution of a cognitive task might be disrupted by something happening in the blackboard ‘behind its back’ during interruption. This class of problem occurs because of the parallelism between the cognitive, perceptual and motor processes. When a cognitive task suspends itself, no other cognitive task may actually gain the focus of attention, but perceptual demons may still be fired and thus change the blackboard contents. Even more insidious, during a spend-time operation, the internal scheduling mechanism may execute some parts of a ballistic action or demon. There are more opportunities for disruption than may first appear. The case of something happening during a spend-time can be illustrated in the following example. In a Task of reading a page, one can imagine a sequence of small spend time that would represent the time reading individual words in the page. If the page just appears to disappear while reading (blown away by the wind for example) it would not be possible to read even though no other Task had interrupted this Task. This example may seem far-fetched, but its does illustrate a not-so-unlikely situation where something in the external world happens at the precise time that the cognitive task dependent on it is executing. Fortunately, because of the architecture of CGF-COGNET, this type of situation can only happen only during a spend-time or a suspension. This is because only during these time-consumption processes can the simulated clock, and hence the environment, be allowed to proceed. Thus, from an algorithmic viewpoint one need only be concerned about a modification in the blackboard or a modification of time which occurred after a spend_time, a suspension, or an interruption.

When any of these happen, a special control can be fired to check if all the conditions are needed to continue execution of the task, and take any appropriate measures otherwise. This control is called a sustainability control. Like the definition of the interruption and resumption control, it can be defined for the cognitive task as a whole, or if desired at lower levels for any Goal, Method or Action. Unlike the interruption and resumption controls, however, when two nested Goals have each their own sustainability control, they are both executed in sequence starting from the most general ones to the most local ones. When a concern for time or blackboard modification is detected, the sustainability control of the cognitive task is first executed, then the one of the most general Goal, and so forth until the most nested goal at the current execution point is reached. Any of these controls may abort or restart the current knowledge chunk they are controlling.

Sustainability controls are a better alternative to resumption controls for maintaining the consistency of the execution of the Task but they may serve other purposes as well. They may be used, for example, to monitor deadlines. The sustainability control would compare the current time with a potential deadline and could affect some execution parameters of the Task to speed it up if necessary. This would be a convenient solution to implement some adaptive reasoning techniques in a real-time context

Manipulation of Cognitive Processing by Metacognitive Controls

In problem-solving systems using the architecture shown in FIG. 1 above, it is possible for multiple cognitive tasks to be triggered for execution at the same time. The problem of ordering the actual execution is important, because the task that is executed first may change both the internal and external situations in a way that may lead the other task(s) to be no longer relevant, or to be executed in a very different way. Typically, the selection of which cognitive task to execute is done through a priority specification, in which a priority is associated with each cognitive task vying to execute, and the focus of attention within the cognitive process is given to the cognitive task with the highest execution. This is done by a component within the cognitive process generically called the cognitive scheduler 420. The process of granting attention always to the cognitive task with the highest priority, however, makes it impossible for the system to execute any cognitive task other than that with the highest priority. A major function of the metacognitive controls 340, 360, 380 is to solve this problem. This is done through the ability of the metacognitive control 340, 360, 380 is to manipulate the priority values indirectly, through a meta-attention process.

A metacognitive control 340, 360, 380 affects the cognitive scheduler 300 by replacing the current priority formula of a cognitive task with a task meta-importance stored in the metacognitive blackboard. This essentially adds a second metacognitive stage to the scheduling process. Initially, each task is assigned a (default) importance reflecting its normal priority, priot to any control activation. If a control needs t reorder tasks, it adjusts the task's meta-importance. Any task with meta-importance will supersede tasks with only default imporatnce. If tasks share the same meta-importance, default importance is used as a tie-breaker. In this way, tasks can be reordered temporarily yet all task ordering knowledge is kept in the metacognitive layer.

### INFRASTRUCTURE

The CGF COGNET incorporates a substantial array of new modeling functionality, as described in the preceding Sections. In many cases, the underlying technology and computing infrastructure in COGNET had to be redesigned to accommodate these capabilities. The infrastructure also had to be engineered to maintain and even improve the execution efficiency of the system, even while all this new functionality was being added. The sum of the major infrastructural changes in CGF-COGNET are summarized below.

Advanced Scheduling Mechanism

The new multi-threaded scheduler mechanism required a significant departure from the previous approach. In conventional COGNET, the existing scheduler allowed the switching of attention from one cognitive task to another. Everything outside the task, however, was executed as a single step operation and thus did not interfere with the scheduler. In CGF COGNET, small chunks of demons and ballistic actions execution had to be interleaved with the execution of the cognitive task to implement the new time consumption mechanism and parallel threads. To do this, a second order scheduling mechanism was implemented on top of the existing Task Scheduler.

To best described how this works, it is easier to first introduce the object oriented approach that has been used for its implementation in C++. There are two basic classes: process and thread. Two new classes derived from process: thread_process and task_scheduler. As expected, thread_process also derives from process. Finally the class task_instance derives from thread. Thread_processes represent the instantiation of demons and ballistic actions

The first degree scheduling works only with processes. The task_scheduler which is also a process is therefore sharing the same scheduling queue as the instantiation of demons and ballistic actions. The Task_scheduler itself is responsible for the scheduling of the Task_instances. When a spend_time operator is encountered, the process from which it is called is put on a time stamped agenda that will be consumed as the internal time is allowed to advance. If the spend-time is in a Task_instance, the entire Task_scheduler is put in the agenda thus preventing any other Task instance from executing. Unlike a suspend, a spend_time signifies that no other activities can take place in the process as the time is being consumed. Parallel processes do not have this constraint and are handled in a traditional time-shared simulated parallelism in the agenda.

Virtual Hypothesis Mechanism

To implement the metacognitive blackboard with minimal penalty on the execution efficiency, a new concept of virtual hypotheses was introduced. Normal hypotheses contain a set of attribute and link values. In a virtual hypothesis, instead of storing the values in attribute, CGF-COGNET only specifies a function for each attribute. This function calculates the value from the an existing data structure. In the case of the Task instance hypotheses for example (see Table 2), the information was directly obtained from BATON's internal representation of the Task instances. With this technique, there is no penalty to maintaining attribute values and there is no performance cost until the virtual hypothesis Is actually used. Without this technique, maintaining and updating the values of each attribute of the metacognitive blackboard would have been prohibitive.

Detect Events Mechanism

A new feature not discussed thus far was also been added to CGF COGNET: the possibility to express triggers in terms of dynamic changes, or events, and not simply in terms of fixed patterns in the blackboard. An event is generated any time a change in the blackboard occurs. Events can be detected with a new detect_event operator that is intended to be used only in trigger conditions. An event can only be used once, therefore, ensuring that a Task can only be triggered at the time that the event occurs. For example, if we consider a Task process_new_track that is sensitive to the creation of a new track, the Task will be triggered only once. If the Task also required other conditions to be triggered that were not satisfied at the time the track was created, the Task will not be triggered, even if the additional conditions became satisfied later.

When used in conjunction with the Task_instance_context argument, the detect event mechanism becomes even more interesting. The task_instance_context argument is used to differentiate different Task instances of the same Task. When used, it gives the possibility to instantiate several Task instances of the same Task at the same time. For example, if the Task_instance_context specified the track found in the trigger condition, one Task instance can be created to attend each track individually.

When using the conventional Find operator to search the blackboard, the trigger condition would only find the last track posted in the blackboard, even if three new tracks were posted at the same time. When using the detect event mechanism, any time an event is consumed by a trigger condition, the trigger condition will be retested with any remaining events. In this particular example, three new Task instances will be created to each attend its own track, and with minimal computational overhead.

### SYSTEM PERFORMANCE

An on-going goal of this research has also been to maintain and even increase the efficiency of CGF-COGNET, even while substantial new functionality was added. There are at least two main reasons for focusing explicitly on efficiency. First, when more than one model is intended to run on a single computer, efficiency translates directly into cost savings. A greater efficiency of the execution engine translates directly into an ability to run more models on that machine, and thus a need for fewer machines. Second, a deeper understanding of efficiency can lead to better models. It was noted earlier that CGF COGNET provides a means to monitor whether the execution of a model is running fast enough to cope with the pace of incoming data. It is, therefore, theoretically possible to create a model that could adapt at anytime to the current load by trading off precision for speed. In this case, raw speed improvement would directly translate to a more accurate model.

The first step to improving system performance is an ability to measure it. It is often the case that intuition about the sources of inefficiency is misleading, and only with precise empirical measurements can actual inefficiencies be found and remedied. The means used to measure performance in the evolving CGF-COGNET are reviewed below, followed by empirical measurement data through time, and some plans for future improvements based on these data.

Measuring Performance

Over the years, a set of tools and techniques has been developed at CHI Systems to measure performance of the BATON execution engine. These began with the creation of a series of C++ stopwatch classes to:

measure time precisely (with a resolution of a microsecond) and

record measurements automatically.

These stopwatch classes can be used both as absolute counters and to provide average times as well as min and max values. The execution engine was then instrumented with these stopwatches to collect performance data easily and accurately.

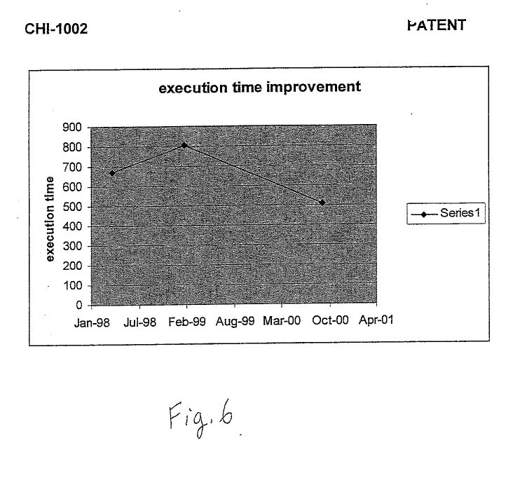

In the current research, an effort was started to automate testing and profiling of system execution to obtain a more fine-grained measurement and feedback regarding the performance of the system. FIG. 6 below shows measurements taken at three points in the project using a common bench mark model. The graph in FIG. 6 was constructed manually by executing the same model with three different versions of COGNET. The oldest version corresponds with the initial COGNET version at the start of the project. It took 671 seconds to execute the benchmark model, which consisted of posting 500 hypotheses with consecutive numerical values of an attribute, finding each individual hypothesis by its attribute value and then unposting it. The second version was the initial CGF-COGNET with the first call stack mechanism. It took 807 seconds for the same model. The final version is the current CGF-COGNET version with the advanced call-stack mechanisms; it took only 511 seconds. All the measures were performed on the same computer. The improvement of the current version is even more significant than it appears, as it includes all of the features discussed in Sections 4 and 5; many of these had not yet been implemented in the intermediate version. Thus, the goal of improving overall efficiency, even after incorporating the new HBR modeling features, has been met.

At the same, the usual warning needs to be issued: the results shown in FIG. 6 are with the benchmark model only, and may not be indicative of all models. The reason for using a benchmark-type model, with abstract operations only, is simple. Because many of the behaviors now model-able in CGF-COGNET could not be represented in the initial system, there is no clear way to compare a more substantive model across the three system versions shown in FIG. 6.

### MODELING AND SIMULATING COOPERATION AND TEAMWORK

One particularly problematic yet critically important aspect of human behavior is the ability of people to interact with each other in a collaborative manner and work in teams. Teamwork is by its nature fluid and adaptive, and thus difficult to model and simulate in anything but a generative manner. The problem is also a deceptive one. Cooperation and teamwork is one of many aspects of human behavior that on first examination seem simple, but which on more examination, have proven very hard to reproduce in a computer. (Language and vision are two other obvious examples). This is largely because, as human beings, we do these things very easily and naturally, not realizing that they arise out of complex underlying information processing mechanisms that have evolved over millions of years and of which we have little conscious awareness.

Existing HBR tools, such as those discussed in Pew and Mavor (1998), focus on the ability of individuals to perform well-defined tasks—taskwork. The ability of these systems to simulate human task-work, however, has not translated into an ability to simulate cooperative interactions. This section discusses ways in which CGF-COGNET seeks to eliminate this limitation, allowing the modeling of team-work and other cooperative behaviors, as well as individual task-work. A brief behavioral science foundation of teamwork and cooperation is provided. The way in which CGF-COGNET can be used to simulate various types of teamwork behavior is then summarized.

The Behavioral Science of Teamwork and Cooperation

Many, if not most, of the work tasks that people perform involve cooperation and multiple-person interactions. The breadth of cooperative activities ranges from complex team-tasks such as occur in command and control or corporate settings to everyday conversation, in which only two people implicitly cooperate to produce an understandable dialog. The behavioral science literature on cooperation and teamwork is enormous, and no attempt can be made to review it here. There are, however, several key distinctions which are most relevant to the goal of simulating cooperation. The first is that taskwork and teamwork are different things. That is, the kinds of behaviors that people must do to cooperate and/or work as a team are different than those which the same people must do to fulfill their individual roles and responsibilities within that team or interaction. The second distinction (and a corollary of the first) is that expertise in taskwork is unrelated to expertise in teamwork. That is, a team of experts is not necessarily an expert team. For example, Smith-Jentsch et al. (1998) analyzed many successful teams and identified four classes of team-work skills which were essential to good team-level performance.

1. exchanging information in a proactive manner—exploiting all available sources of information to assess key events, passing information to the appropriate persons before having to be asked, and providing situation updates to teammates;

2. giving proactive guidance—providing guidance which enables teammates, particularly subordinates or collaterals, to perform their tasks more effectively, and stating clear and appropriate priorities.

3. taking compensatory actions—making prompt correction of teammate errors, and providing and/or requesting backup promptly;

4. employing effective communications—using clear phraseology and speaking intelligibly, providing complete reports or accounts of internal and external events of team relevance, and minimizing unnecessary chatter.

The behaviors that arise from these skills are clearly different than those needed to perform the separate taskwork that the members of the team are performing.

A third distinction is that cooperation and teamwork are behaviors which are based on shared understanding and goals. All the skills described above rely to one degree or another on the team members sharing some understanding of why they are cooperating and what they are trying to accomplish. Consistent with this view, Converse, et al. (1991) and Duncan et al. (1993) have suggested that the degree to which team members share mental models of how to deal with an evolving tactical situation will greatly enhance their chances of team success, and Zachary and Robertson (1990) define cooperation as action based on shared goals.

These points can illustrate why cooperative behaviors are hard to simulate. For a simulated entity to be cooperative, it needs to have taskwork skills as well as teamwork skills, and must have the abilities, at some non-trivial level, to:

relate its own taskwork performance to the activities and skills of teammates

understand shared (team) goals, and

relate its taskwork goals and skills to the larger needs and situation of the team.

Modeling Teamwork and Cooperation in CGF-COGNET

The analysis above suggests that teamwork capabilities must be built on top of the taskwork abilities. In particular, several capabilities are needed in addition to general taskwork capabilities:

Performance self-assessment. A model capable of engaging in teamwork needs to be able to understand its own limitations and assess its ability to perform in different contexts, so that it can know how to interact and share work with others. The self-assessment ability requires the model to have an awareness of the limits to its own knowledge and an ability to reason about those limits with regard to the current problem instance.

Performance robustness. Cooperating models need to handle the interruptions and unforeseen events that arise in the context of both routine teamwork activities and more free-form spontaneous cooperation, adapting its behavior to meet its goals in these fluid settings. These capabilities require an awareness of the internal information processes and an ability to suspend them, and to manipulate and adapt them to novel situations. These are metacognitive processes.

Coordination. A teamwork model needs to be able to adapt its information processing to the actions and/or characteristics of others in the work team in order to coordinate with teammates. This requires an ability to reason about and modify first order task-work cognitive processes, to meet cooperative ends.

Self-explanation. Just as humans must often explain their actions and decisions, cooperative models may also be required to do so. Historically, self-explanation approaches that involve simply repeating the decision process (a common approach with expert systems) have proven unacceptable to the people receiving the explanation. Rather, the models will need the ability to reason about their own general or abstract procedure or knowledge and answer specific questions about these.

The kinds of internal processing described above require the model to be aware of its own status and problem-solving state, to undertake (metacognitive) reasoning about the relationship of their activities to the larger team process, to be aware of the states of other team members, and to apply the above four items as meta-level strategies to keep the team functioning. These capabilities were provided by the metacognitive features of CGF-COGNET, which include:

the cognitive proprioception instrumentation of the information processing mechanisms that provide a self-awareness of cognitive processes;

the self-awareness blackboard declarative knowledge structure, which contains the cognitive proprioception information;

the metacognitive knowledge structures (i.e., controls) that encode domain-specific proactive, reactive, and introspective metacognitive strategies and that allow the first-order (i.e., task-work) cognitive processes to be reasoned about and controlled to achieve collaborative and teamwork goals;

the capability to create resource designations for information processing resources and to monitor those resources with controls to avoid deadlock situations; and

sustainability and resumption controls that provide interruption recovery for taskwork procedural knowledge.

In general, most of the broad range of behaviors that can be considered as cooperative can be simulated using the self-awareness provided by the self-awareness blackboard, and a combination of proactive, reactive, and/or introspective controls. The self-awareness blackboard can provide a cooperative awareness by providing an explicit representation of the relation of the task-work being carried out by the individual to the larger goals and processes of the team. For example, it will contain knowledge that ‘self’ is working on Task A right now, but Task A completion depends on Task B which is being performed by a different person. This self-awareness establishes an inherent need for collaboration between the two individuals and tasks. Various types of cooperation could be represented with controls that work from the declarative knowledge on the self-awareness blackboard. For example, the implicit dependency between the two tasks might trigger a proactive control in the first person to remind the second person that their own completion of Task A is dependent on the other's completion of Task B. Alternatively, when Task A comes to a point where it can't continue without input from Task B, a reactive control may be triggered, representing a focused request for task completion (or at least input) from the other individual.

This general strategy for simulating cooperation is considered in somewhat more detail below for four of the skills of Smith-Jentsch et al. (1998), which were discussed above:

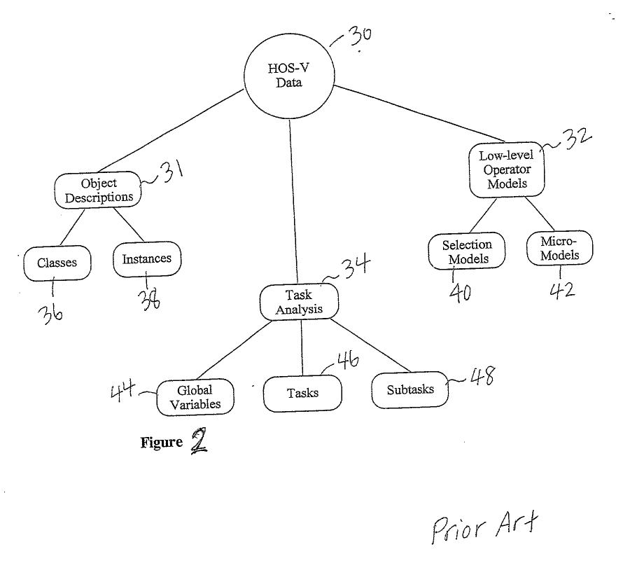

Proactive information exchange. In the generic case discussed above, proactive information exchange did not occur. Rather, the ‘self’ in that example case actively reminded the other agent to provide the information. Within the general structure of collaboration given in FIG. 2, proactive information exchange might be modeled through two separate metacognitive processes. The first process is a reactive process that would be triggered as soon as the cognitive system (‘A’) became aware that a teammate (‘B’) was beginning a task that might require information from A. This contingency would be posted on the self-awareness blackboard, and its presence would then trigger two other metacognitive processes. One would be a proactive control, that would periodically seek information on how close the second individual was to needing input. The other would be a reactive process that would cause A to interrupt its cognitive processes as soon as the information input was available, and communicate it to B in a proactive manner so as to continue the flow of work.

‘Other’ performance assessment. The essentially interactive nature of cooperation and team work requires that individuals periodically assess the performance of their teammates, e.g., to determine if they need help, can take on more work, etc. This is a behavior that builds on the metacognitive awareness that a task/function could be performed either by the ‘self’ or by a teammate. This awareness would need to be part of a domain-specific self-awareness blackboard which would need to contain knowledge about the inter-relationships among tasks with regard to the various members of the current team, and possibly heuristic knowledge and/or episodic knowledge about the performance of the other team members either locally (i.e., in the current watch) or globally (i.e., in general). A proactive control could be constructed that was activated in case of an opportunity to shed a task to another agent. This control could use this metacognitive blackboard knowledge about the team as it analyzes the procedural knowledge that comprised the task in question, to assess whether the agent to whom the task might be given has the ability to perform it.

Proactive guidance. This type of teamwork behavior can be modeled using a combination of the strategies discussed above to model proactive information exchange and to model ‘other’ performance assessment. To model proactive guidance, the general representation of collaboration given above would be supplemented with two additional metacognitive controls. One would be a proactive control that periodically assesses the performance or work quality of other members of the team, particularly subordinates, using mechanisms similar to those discussed above for ‘other assessment.’ In this case, though, assessment would simply qualitatively determine whether the teammate was judged to be ‘in trouble’ or potentially unlikely to complete some task successfully. The frequency with which this assessment is activated could be based on the trend in the other agent's performance—as performance begins to deteriorate, then it would be assessed more often. Once an assessment is posted on the metacognitive blackboard that another agent is having difficulty, then appropriate procedural knowledge (perhaps in the form of a proactive control, or perhaps in the form of a primary cognitive task) would be triggered to provide guidance or help in a proactive manner, rather than in a reactive manner as described below.

Compensatory actions. Compensatory teamwork action is a reactive version of the proactive guidance behavior. That is, the cognitive system identifies a problem caused as a result of an action taken by a teammate, and then reacts to it. Most of this processing can actually be accomplished by first order cognitive processes (e.g., via cognitive tasks within the COGNET framework), as the problem is first perceived and then internalized, at which point it may stimulate a corrective or compensatory action. However, this process can be facilitated by the self-awareness of interdependencies of own and other's tasks, which can structure the process of determining whether the problem is one which the cognitive system should attempt to correct.

### SUMMARY AND CONCLUSIONS

The primary objective of this invention is to improve capabilities to construct human performance models for a variety of defense and other applications, emphasizing the integrated representation of cognitive, perceptual, and motor performance. The application of principal interest is that of constructing computer-generated forces (CGFs) for use in large-scale distributed simulations of military forces. The military significance of this will derive from the resulting availability of a toolset and framework for human behavioral representation (i.e., CGF-COGNET) that is highly usable and efficient and which can produce the kinds of simulation outputs needed by the principal Navy modeling and simulation applications for training, embedded training, mission rehearsal, system evaluation, intelligent interfaces, and intelligent agents in general. CGF-COGNET provides novel capabilities in the areas of:

sensory/motor abilities—it has created a flexible means to represent and simulate sensory and motor behaviors with regard to performance timing, accuracy, and systemic limitations;

meta-attention—it has developed a means to extend the original task-driven attention framework of COGNET to incorporate self-awareness of the cognitive process and meta-level control of cognitive and perceptual/motor processing based on this self-awareness;

metacognition integration—it has integrated the COGNET extensions to represent self-awareness and metacognitive mechanisms for error-recovery into the architecture developed here;

individual differences and situational effects—it has defined and implemented mechanisms to represent individual differences (and/or population distributions) in sensory/motor performance and under different levels of behavior moderating factors such as stress or fatigue;

representational scalability—it has defined the cognitive and behavioral representational scheme so that there is no fixed starting point in the representational process (e.g., the working memory element), but rather an ability of the CGF modeler to define an appropriate foundational level given the human behavioral requirements of a specific CGF application;

memory enhancements—it has separated the long-term and short term memory components, so that memory effects such as forgetting and mis-remembering can be expressed in the behavioral representation;

computational scalability—it has implemented the above capabilities so that complex simulations of realistic behavior, such as the need to drive training exercises/simulations, can be implemented and executed with low-cost desktop computing technology; and

usability—it has extended and modified the model-development interface of the resulting CGF-COGNET representation/simulation system to keep it maximally usable by developers of CGF simulations with minimal or no training in cognitive or behavioral science.

The technology defined above was implemented in three new components of the CGF-COGNET system:

1. Core execution infrastructure. In this component, goals of scalability and usability were met by developing a new call stack scheduler and an event-detection mechanism that simplified the pattern-matching process. Together, these dramatically increased the efficiency of the model execution, which was assessed through a performance benchmarking process that was also developed in this past year. To increase usability, facilities were created to allow the model-developer to create temporal ‘threads’ within the initialization process, effectively allowing the external world to be simulated from within the development environment and simplifying model testing and debugging. Additionally, the communication shell layer of the system was made compatible with the HLA architecture now used for most CGF simulations, and various functions were added to allow shell developers to monitor the behavior of the shell, again simplifying development, debugging, and testing of CGF simulation models.

2. Performance Representation Extensions. The existing cognitive modeling functionality in COGNET was extended to support the representation and simulation of the time/accuracy aspects of sensory and motor system performance, in three primary ways. First, the fundamental execution architecture was modified to permit truly parallel execution threads in each of the three subsystems of the architecture (cognitive, sensory/perceptual, and motor). Second, the ability to consume or spend time in any execution thread was implemented. Together, these first two extensions allow, for example, a motor action (e.g., button push) to be initiated from within a cognitive task but to be executed as a separate time-consuming thread of activity within the motor system, continuing in parallel to the continuation of cognitive activity within that cognitive task. Third, a micromodel construct was created, allowing context-sensitive invocation of a low-level model of the time and/or accuracy involved with a specific intended activity (motor or sensory) along any execution thread. The micromodel construct also enables the representation of moderators such as stress and fatigue (when system self-awareness is used as part of the invocation context), as well as individual differences in performance.

3. Metacognition Extensions. The capabilities for system self-awareness were implemented with a set of functions that allow the cognitive process to modify cognitive processing accordingly (and through it, motor and volitional perceptual processing). Particularly important was the added ability to recover from interruptions and/or failures to accomplish goals/actions in a graceful and context-sensitive manner.

This research has produced three primary products to date.

1 An architecture for integrating representations of human cognition and sensory/motor behavior in complex environments, based on elements of prior COGNET and HOS research, called CGF-COGNET.

2. A software implementation of the CGF-COGNET architecture, incorporating advanced behavioral simulation infrastructure, new behavioral representation capabilities (including performance time and accuracy prediction), and self-awareness of internal processing states and the ability to modify cognitive and motor processing on the basis of this self-awareness.

3. A series of applications of CGF-COGNET software to various problems, both demonstrative and substantive, showing various capabilities of the kind required for CGF modeling in both tactical and command-and-control roles. The applications have included simulation of human performance in an abstracted air traffic control environment, and simulation of human performance in a voice-based office-like environment, as well as several others.

The scientific significance of this research derives from its addressing the problem of composability of human information processing models using component representations with varying levels of granularity. This ability is crucial to enable the flexible use of the growing body of component models from psychology, human factors, computer-human interaction, and cognitive science research to solve applied problems in engineering, simulation, and design. This research is also significant in that it provides not just a theoretical solution but also an integrative software framework for creating specific model-applications using this principle of flexible composability.

The commercial significance of this research lies in its development of a general technology for modeling and simulation of human capabilities in complex, real-time environments, which are of central importance in many industries, including (non-military) aerospace, process control, manufacturing, medicine, financial services, transportation, and telecommunications. The ongoing transfer of technology developed in this contract to commercially-available tools will provide these industries with a cost-effective way of creating and incorporating models of human information processing into the development of training systems, into the design evaluation/validation processes, into the development of decision support and performance support systems, and into the creation of intelligent task automation solutions.

The technology created by the current invention makes it possible to capture and ‘bottle’ human expertise in software, and use that software to replace humans in complex systems, or to permit less-capable individuals to perform complex tasks through provision of decision support. In complex real-time environments, such decision support will require several types of behaviors not currently found in computational cognitive models. These include human-like performance self-assessment, performance robustness, cooperation, and self-explanation. Each of these, however, can be generated with the metacognitive capabilities of the present invention:

Performance self-assessment—a simulated or synthetic system operator (i.e., synthetic human) needs to be able to understand its own limitations and assess its ability to perform in different contexts, whether this context is an actual operational system or simply a simulation of that system during the design process. This ability is key to providing realistic estimates/predictions of human performance during the design phase, and is also key to realistic simulation and/or performance of key work behaviors such as workload sharing and effective task management. The self-assessment ability requires an awareness of the limits to its own knowledge and an ability to reason about those limits with regard to the current problem instance. These are metacognitive processes.

Performance robustness—a simulated or synthetic system operator (i.e., synthetic human) need to handle the interruptions and unforeseen events that arise in the context of both routine activities and unusual activies (e.g, during emergencies). The synthetic system operator, like the person being simulated (in the engineering setting) or replaced/supported (in the operational setting) will have to be able to deal with interruptions and novel settings and recover or adapt its behavior to meet its (mission) goals in these novel settings. These capabilities require an awareness of the internal information processes and an ability to suspend them, and to manipulate and adapt them to novel situations. These are metacognitive processes.

Cooperation—cognitive models that are embedded into interactive applications such as decision support will need to be able to adapt their information processing to the actions and/or characteristics of their human users and behave in a cooperative manner. This requires an ability to reason about and modify their first order cognitive processes, a metacognitive ability.

Self-explanation—just as humans must often explain their actions and decisions, synthetic system operator also need to be able to do so. Historically, self-explanation approaches that involve simply repeating the decision process (a common approach with expert systems) has proven unacceptable to the people receiving the explanation. Rather, the models will need the ability to reason about their own general or abstract procedure or knowledge and answer specific questions about these. These are metacognitive abilities.

The number of people used to operate complex systems and perform complex job functions will continue to decrease in the future, and as a result the number of functions for which each person is responsible will increase. Even if selective automation reduces the overall degree of human responsibility, simple arithmetic dictates that each person in advanced systems such as combat systems, manufacturing systems, even healthcare systems, will need to be more productive than her or his counterpart of today. It is assumed that these future systems will be better designed and have more automation and more automated infrastructure, and that the elimination of ‘stovepipe’ engineering will replace many dedicated single-function workstations with a smaller number of more generalized and powerful ones (e.g., multi-modal workstations). In order to allow fewer people to do more with these less specialized workstations, the workstation itself will have to actively provide performance support to its human users in the form of intelligent interfaces and task-management software, in other words, decision support in the form of active work management.

Concepts of active work management have been discussed and investigated for well over two decades as a means of achieving an efficient blending of human and automation resources in the accomplishment of a complex suite of tasks/functions in a time-stressed environment (see, e.g., Rouse, 1976). The basic underlying concept is to dynamically assign tasks/functions to human and/or automation agents in such a way as to achieve a favorable balance in performance and agent state (e.g., workload and skill levels) characteristics. A key characteristic of the environment is whether the performance agents are all humans or a combination of humans and automation, or all automated.

If only humans are involved in task performance, then the concept is typically referred to as workload sharing (which may or may not be mediated by an automated allocation agent), or as computer supported cooperative work (CSCW) if a computer-based agent is used to drive or contribute to the task allocation process (see, e.g. Robertson, Zachary, and Black, 1990). If some of the performance agents are automated (i.e., synthetic humans provided by cognitive models), then the concept may be referred to as adaptive automation (Parasurman et al., 1991) or dynamic function allocation. When only a single human agent and single workstation is involved and that person's workload is the focus of the management process, then the concept is often termed intelligent HCI, or sometimes task management. In the case where all the performance agents are automated, the concept is termed distributed problem solving (Smith, 1980).

Whenever a human agent must dynamically share functions with another agent (human or automated), the human agent—at least an expert one—engages in reasoning about the other agent and its relationship to the situation at hand. (For discussion purposes, the person or automated agent who is considering a dynamic management of work tasks and/or functions will be referred to as the first agent. The other agent to whom the work task/function may be dynamically allocated, will be referred to as the second agent whether that second agent is human or automated.) Regardless of the work management concept, the first agent must reason about:

its own state—estimating or assessing its own workload and ability to perform the work that could be allocated to the second agent;

the cost of allocation—attempting to determine the adjustments that it would have to make in its own activities (e.g. extra communications, system interactions, etc.) in order to effect the allocation of the function to the second agent. Typically these are activities that would not have to be done if the first agent retained the function for itself.

the second agent's ability—determining if the second agent is able to undertake the function under consideration, given the current situation and problem conditions. For human second agents, ability may be indicated by whether the agent has been qualified or trained to perform the task, particularly under the current conditions. For automated second agents, the ability may be assessed in more situational terms, e.g., whether the agent has a data path to the necessary information, has enough processing capability available, etc.

its confidence in the second agent—even if the second agent is able to perform the function, it may not be able to do it well or reliably. The first agent will develop beliefs or inferences about the possible quality of the result if the second agent is given the opportunity to perform the task.

These are all metacognitive processes. The first two deal with the first agent's ability to reason about its own internal problem-solving process and the possible consequences of modifying it. The latter two deal with the interactive aspect of metacognition, the ability of the agent to reason about the internal cognitive processes of other agents in a multi-agent setting.

Metacognition Based Decision Support

One implementation for application according to the present invention is as follows:

Performance self-assessment. This type of behavior can be modeled using the metacognitive blackboard together with various metacognitive controls. The metacognitive blackboard provides an awareness of the current state of the internal information processing mechanisms (e.g., what task is being executed, which other ones are activated waiting to be executed, etc.) which forms the declarative knowledge basis for the self-assessment process. The actual logic of assessing whether the system can perform a specific task or function, would be embedded into an introspective variant of a proactive control, or more likely multiple controls for different types of self-assessment. These controls would examine the current state of the system and its likely future activity (based on reasoning about information in the metacognitive blackboard), and on information on the estimated cognitive processing (and/or motor processing) demands of the task in question.

Performance robustness. The ability to maintain consistency and graceful performance under interruption, high workload, etc. can be modeled by a combination of resource locks and reactive controls. Simple interruption recovery is handled by coordinated use of resource locks and reactive controls (specifically interrupt-activated and deadlock-activated controls). More complex graceful performance degradation would require use of reactive controls that use information in the metacognitive blackboard to adjust the problem-solving process to the (current) situation, by rescheduling, canceling, or truncating certain tasks or task instances via the metapriority construct.

Cooperation. There is actually a broad range of behaviors that can be considered as cooperative (see, for example, various papers in Robertson, Zachary, and Black, 1990), but most can be simulated using the self-awareness provided by the metacognitive blackboard, and a combination of metacognitive controls. The metacognitive blackboard can provide a cooperative awareness by containing knowledge that ‘self’ is working on Task A right now, but Task A completion depends on Task B which is being performed by a different person. This self-awareness establishes an inherent need for collaboration between the two individuals and tasks. Various types of cooperation could be represented with metacognitive controls that work from the declarative knowledge. For example, the implicit dependency between the two tasks might trigger a proactive control in the first person to remind the second person that their own completion of Task A is dependent on the other's completion of Task B. Alternatively, when Task A comes to a point where it can't continue without input from Task B, a reactive control may be triggered, representing a focused request for task completion (or at least input) from the other individual.

Self-explanation. The process of self-explanation is enabled by the self-awareness provided by the metacognitive blackboard, and carried out by proactive (introspective) controls that are able to extract information from the metacognitive blackboard, and to communicate it to some other agent/person.

Cost of allocation. This behavior involves the process of assessing the second order effects of reallocating an element of work across a team. This behavior can be modeled as a special case of performance self-assessment described above, in which the proactive control can examine the potential implications of having another agent perform a process that would otherwise be performed internal to that system. This control could, for example, analyze the procedural knowledge itself and determine what additional communications might be required, what temporal and/or physical dependencies might be established, etc., and estimate their overall impact on the process, yielding perhaps a judgment of ‘more work to give it away’, or ‘save work by off-loading’.

‘Other’ performance assessment. This is a behavior that builds on the metacognitive awareness that a task/function could be performed either internally or by another agent (i.e., human teammate or synthetic cognition agent). This awareness would likely be part of domain-specific metacognitive blackboard content, which would need to contain knowledge about the inter-relationships among tasks with regard to the various members of the current team (human and synthetic), and possibly heuristic knowledge and/or episodic knowledge about the performance of the other team members either locally (i.e., in the current watch) or globally (i.e., in general). A proactive control could be constructed that is activated in case of an opportunity to shed a task to another agent. This control could use the metacognitive blackboard knowledge about the team as it analyzes the procedural knowledge for the task in question, to assess whether the agent to whom the task might be given has the ability to perform it.

Task shedding. This behavior can be modeled essentially as a combination of other behaviors already discussed. It relies on the metacognitive awareness of a potentially shared task setting, as discussed above, and several proactive controls. One of these controls would simply identify situations in which the shedding of tasks should be considered, for example, by being activated in times of high workload (e.g., awareness of many things to be done at the same time). This control might simply consider the costs of re-allocating the various tasks (as discussed above), and identify tasks that could be shed to others productively. These tasks might then be posted back to the metacognitive blackboard as opportunities to shed a task, which would trigger the ‘other’ performance assessment control discussed above. That control would identify specific agents within the team to which each sheddable task could be allocated, and then prioritize them. A first order process (i.e., cognitive task) to interact with the other agent and affect the ‘hand-off’ might then be triggered by the posting of this information on the metacognitive blackboard, after which a reactive control might then adjust the metacognitive properties and other metacognitive blackboard information to reflect the awareness that this task (instance) is now being performed by another agent. Interestingly, such a modification of the metacognitive blackboard could then create other threads of cooperative activity (see above and below) to deal with the new interdependencies created by this task shedding process. A similar process might control the process by which tasks are simply shed altogether, rather than shed to other team members.

Task acquisition. This behavior is the complement of the task shedding behavior discussed above. When one agent sheds a task to another, the second agent must acquire the task, which involves several levels of metacognitive processing. In general, however, this side of the dyad is less complex than the other, as the receiving agent will have less need to integrate the new task into its larger problem solving process than the shedding agent will have to maintain its integration, even though it is being performed by another agent. At the simplest level, the process of acquiring a task can be accomplished by a single proactive control that is able to internalize the task and insert it into the metapriority structure, ensuring that it is performed in a timely manner.

It is to be understood, however, that even though numerous characteristics and advantages of the present invention have been set forth in the foregoing description, together with details of the structure and function of the invention, the disclosure is illustrative only, and that although changes may be made in detail, especially in matters of shape, size and arrangement of parts, as well as implementation in software, hardware, or a combination of both, the changes are within the principles of the invention to the full extent indicated by the broad general meaning of the terms in which the appended claims are expressed.

TABLE 1
COGNET Principles of Operation

| Principle name | Definition |
|---|---|
| Attention Focus | At any point, the cognitive process is executing, |
| | at most, one chunk of procedural knowledge, |
| | called a cognitive task. The executing cognitive |
| | task is said to have the focus of attention of the |
| | cognitive process. |
| Pattern-based | Each cognitive task includes a trigger condition to |
| Attention Demand | determine if it is relevant to the internal under- |
| | standing of the external world, as maintained |
| | in memory. Only when the trigger condition is |
| | met does the task become active and vie for |
| | attention. |
| Attention Capture | Each cognitive task includes a context sensitive |
| | measure of its relative priority, which is evaluated |
| | based on the contents of memory when the task is |
| | activated. An activated cognitive task will |
| | capture the focus of attention if its priority |
| | exceeds those of all other active cognitive tasks. |
| Task Interruption | An executing cognitive task which loses the focus |
| | of attention through Attention Capture has been |
| | interrupted and continues to compete for |
| | attention. |
| Cognitive Process | Cognitive operators within cognitive tasks can |
| Memory Modification | change the state of memory when they are |
| | executed. |
| Perceptual Process | Self-activating perceptual knowledge sources |
| Memory Modification | called demons change the state of memory when |
| | executed by the perceptual process. |
| Multiple Cognitive | A cognitive task may be activated for execution in |
| Task Instances | the context of a specific piece or configuration of |
| | knowledge in memory, which is called its scope. |
| | Such a cognitive task may have multiple active |
| | instances, with each instance reflecting a unique |
| | instance scope. Multiple cognitive task instances |
| | compete for attention as if they were individual |
| | cognitive tasks. |
| Task Suspension | A task may relinquish attention, based on task |
| | knowledge and the state of memory. Upon such |
| | suspension, all remaining active tasks vie for |
| | attention. The suspended task sets a resumption |
| | condition which determines when it will be |
| | reactivated and resume competing for attention. |

TABLE 2

| | | Links/Reverse |
|---|---|---|
| Level name | Attributes | links |
| Task | Name | Instances/Task |
| | Number of started instances | Model/Tasks |
| | Total time spent | |
| | Number of interruptions | |
| | Number of suspensions | |
| | Number of Goal executions | |
| | Number of Determine calls | |
| | Number of Method calls | |
| | Number of Cel action calls | |
| | Number of Ballistic action invocations | |
| | Number of Micro model calls | |
| | Number of Calculate calls | |
| | Number of C ++ action calls | |
| Task Instance | ID | Task/Instances |
| | Priority | |
| | Status | |
| | Context | |
| | Trigger time | |
| | Activation time | |
| | Time spent | |
| | Remaining time to spend | |
| | Number of interruptions | |
| | Number of suspensions | |
| | Number of Goal executions | |
| | Number of Determine calls | |
| | Number of Method calls | |
| | Number of Cel action calls | |
| | Number of Ballistic action calls | |
| | Number of Micromodel calls | |
| | Number of Calculate calls | |
| | Number of C ++ action calls | |
| Model | Name | Tasks/Model |
| | Time Spent | |
| | Shell queue size | |
| | shell queue latency | |
| | shell queue next time update | |

What is claimed is:

1. A method of simulating human behavior for interacting with environment, comprising:
defining resources that simulate the human behavior based upon resource definitions, said resource definitions defining at least cognition, sensory, motor and metacognition based upon attributes;
representing certain internal aspects of said resources in symbolic knowledge;
storing said symbolic knowledge in a predetermined metacognitive memory;
updating said symbolic knowledge for each of said resources in response to any change that is related to said resources; and
managing said resources for at least one cognitive task based upon said symbolic knowledge.

2. The method of simulating human behavior according to claim 1 wherein said certain internal aspects of said resources include a state of usage and an internal request for usage, the usage including certain elements of said symbolic knowledge and certain aspects of processing capability of said resources.

3. The method of simulating human behavior according to claim 1 wherein said attributes are context sensitive.

4. The method of simulating human behavior according to claim 1 wherein said attributes include psychological and physical status.

5. The method of simulating human behavior according to claim 1 wherein said managing is proactive.

6. The method of simulating human behavior according to claim 1 wherein said managing is reactive.

7. The method of simulating human behavior according to claim 1 wherein said managing is introspective.

8. The method of simulating human behavior according to claim 1 wherein said change includes an internal change in said resources.

9. The method of simulating human behavior according to claim 1 wherein said change includes an external change in the environment.

10. The method of simulating human behavior according to claim 1 wherein said symbolic knowledge includes tasks for defining a predetermined set of the cognitive tasks, task instances for defining a currently existing instance of the cognitive tasks and models for defining a domain specific application.

11. The method of simulating human behavior according to claim 1 wherein said managing includes prioritizing allocation of said resources, recovering from interruptions, resolving an internal conflict of said resources.

12. The method of simulating human behavior according to claim 1 wherein said resource definitions include user-definable attributes that are granularly modifiable.

13. The method of simulating human behavior according to claim 1 wherein said resource definitions include predetermined attributes.

14. A system for simulating human behavior for interacting with environment, comprising:
an editor for defining resources that simulate the human behavior based upon resource definitions, said resource definitions defining at least cognition, sensory, motor and metacognition based upon attributes;
a cognitive proprioception unit for detecting a change that is related to said resources;
a symbolic transformation unit connected to said cognitive proprioception unit for representing certain internal aspects of said resources in symbolic knowledge;
a metacognitive memory for storing said symbolic knowledge; and
a metaconitive control unit connected to said metacognitive memory for managing said resources for at least one cognitive task based upon said symbolic knowledge.

15. The system for simulating human behavior according to claim 14 wherein said certain internal aspects of said resources include a state of usage and an internal request for usage, the usage including certain elements of said symbolic knowledge and certain aspects of processing capability of said resources.

16. The system for simulating human behavior according to claim 14 wherein said attributes are context sensitive.

17. The system for simulating human behavior according to claim 14 wherein said attributes include psychological and physical status.

18. The system for simulating human behavior according to claim 14 wherein said metaconitive control unit manages said resources in a proactive manner.

19. The system for simulating human behavior according to claim 14 wherein said metaconitive control unit manages said resources in a reactive manner.

20. The system for simulating human behavior according to claim 14 wherein said metaconitive control unit manages said resources in an introspective manner.

21. The system for simulating human behavior according to claim 14 wherein said cognitive proprioception unit detects said change that is an internal change among said resources.

22. The system for simulating human behavior according to claim 14 wherein said symbolic knowledge includes tasks for defining a predetermined set of the cognitive tasks, task instances for defining a currently existing instance of the cognitive tasks and models for defining a domain specific application.

23. The system for simulating human behavior according to claim 14 wherein said metaconitive control unit manages prioritizing allocation of said resources, recovering from interruptions, resolving an internal conflict of said resources.

24. The system for simulating human behavior according to claim 14 wherein said resource definitions include user-definable attributes that are granularly modifiable.

25. The system for simulating human behavior according to claim 14 wherein said resource definitions include predetermined attributes.

26. A computer program for providing real-time adaptive decision support, comprising:
a predetermined set of resources for accomplishing a set of predetermined tasks;
a cognitive module connected to said resources for executing at least one of the tasks, said cognitive module further including a cognitive scheduler, the task being defined by a task control declaration and being managed by said cognitive scheduler; and
a metacognitive module operationally connected to said cognitive module and having a metacognition process control module, a metacognition memory and a metacognition scheduler, in response to said cognitive module said metacognitive module updating symbolic information on self-awareness of said resources in said metacognition memory in response to any change that is related to said resources, said metacognition process control module reordering the tasks in said cognitive scheduler based upon said symbolic information and said metacognitive scheduler module.

27. The computer program for providing real-time adaptive decision support according to claim 26 wherein said metacognition process control module further includes a reactive control module and a proactive control module.

28. The computer program for providing real-time adaptive decision support according to claim 27 wherein said cognitive module based upon a first portion of said task control declaration triggers control in said reactive control module.

29. The computer program for providing real-time adaptive decision support according to claim 27 wherein said cognitive module based upon a second portion of said task control declaration updates certain information in said symbolic information in said metacognition memory.
